(19) United States
(12) Patent Application Publication
(10) Pub. No.: US 2011/0069286 A1
(43) Pub. Date: Mar. 24, 2011

(54) PROJECTION DISPLAY APPARATUS

(75) Inventors: Yusuke Itoh, Toyonaka-City (JP); Shinya Matsumoto, Hirakata-City (JP); Ken Mashitani, Hirakata-City (JP); Takahisa Ando, Ikoma-City (JP); Nobuyuki Kondou, Moriguchi-City (JP); Takashi Ikeda, Higashi Osaka-City (JP)

(73) Assignee: SANYO ELECTRIC CO., LTD., Moriguchi City (JP)

(21) Appl. No.: 12/725,937

(22) Filed: Mar. 17, 2010

(30) Foreign Application Priority Data
Apr. 13, 2009 (JP) 2009-097490
Jul. 31, 2009 (JP) 2009-179667

(51) Int. Cl. G03B 21/20

(52) U.S. Cl. 353/119

(57) ABSTRACT

A projection display apparatus includes a housing case housing a plurality of light sources, a reflective light valve, and a projection unit. The housing case has a base plate and a ceiling plate. The ceiling plate is provided with a transmission area and a projection-plane-side shield plate, the transmission area being an area through which light emitted from the projection unit passes, the projection-plane-side shield plate being placed closer to the projection plane than the transmission area. The projection-plane-side shield plate is configured to shield unwanted light being other than light forming an image among light passed through the transmission area.

### CROSS REFERENCE TO RELATED APPLICATIONS

This application is based upon and claims the benefit of priority from prior Japanese Patent Application No. 2009-097490, filed on Apr. 13, 2009; and Japanese Patent Application No. 2009-179667, filed on Jul. 31, 2009; the entire contents of which are incorporated herein by reference.

### BACKGROUND OF THE INVENTION

1. Field of the Invention

The present invention relates to a projection display apparatus which includes; a light source, a reflective light valve configured to modulate light emitted from the light source, and a projection unit configured to project light emitted from the reflective light valve on a projection plane.

2. Description of the Related Art

Recently, there has been known a projection display apparatus including a solid light source such as a laser light source, a light valve configured to modulate light emitted from the solid light source, and a projection unit configured to project the light outputted from the light valve on a projection plane.

A technique has been known in which a reflective light valve, such as a digital micromirror device (DMD), is used as the light valve. Another technique has been proposed in which an aperture shields light other than that forming an image, namely unwanted light, among light reflected by the reflective light valve (for example, Japanese Patent Application Publication No. 2002-122938). Specifically, the aperture is placed near the reflective light valve, and is configured to shield unwanted light reflected by the reflective light valve, near the reflective light valve.

As described above, near the reflective light valve, the aperture shields unwanted light reflected by the reflective light valve. Specifically, the aperture shields unwanted light near an object plane of a projection lens. In the projection display apparatus, when the aperture is away, even a little, from the reflective light valve placed at the object plane, unwanted light cannot be removed sufficiently.

### SUMMARY OF THE INVENTION

A projection display apparatus of first aspect includes a housing case (housing case 200) housing a light source (red solid light sources 111R, green solid light sources 111G, blue solid light sources 111B); a reflective light valve (DMD 500R, DMD 500G, DMD 500B) configured to modulate light emitted from the light source; and a projection unit (projection unit 150) configured to project light emitted from the reflective light valve on a projection plane. The projection display apparatus is placed along a first placement face substantially parallel to the projection plane and along a second placement face substantially orthogonal to the first placement face. The housing case has a base plate (base plate 230) and a ceiling plate (ceiling plate 240), the base plate facing the second placement face, the ceiling plate being provided on an opposite side to the base plate. The ceiling plate is provided with a transmission area (transmission area 185) and a projection-plane-side shield plate (projection-plane-side shield plate 800). The transmission area is an area through which light emitted from the projection unit passes. The projection-plane-side shield plate is placed closer to the projection plane than the transmission area. The projection-plane-side shield plate is configured to shield unwanted light being other than light forming an image among light passed through the transmission area.

In the first aspect, the ceiling plate has a side shield plate (side shield plate 801A, side shield plate 801B) provided adjacently to the transmission area in a horizontal direction parallel to the projection plane. The side shield plate is configured to shield unwanted light being other than light forming an image among light passed through the transmission area.

In the first aspect, the projection-plane-side shield plate has a shape extending in a horizontal direction parallel to the projection plane. An area (neutral density filters 830, diffuser plates 840, small holes 850) having a predetermined transmittance is provided to each of end portions of the projection-plane-side shield plate in the horizontal direction parallel to the projection plane.

In the first aspect, the projection display apparatus further includes a support mechanism configured to support the projection-plane-side shield plate movable in an orthogonal direction to the projection plane.

In the first aspect, the projection display apparatus further includes a support mechanism configured to support the projection-plane-side shield plate movable in a direction orthogonal to both of a horizontal direction parallel to the projection plane and a direction normal to the projection plane.

### BRIEF DESCRIPTION OF THE DRAWINGS

FIG. 1 is a perspective view of a projection display apparatus 100 according to a first embodiment.

FIG. 2 is a view of the projection display apparatus 100 according to the first embodiment when viewed from side.

FIG. 3 is a view of the projection display apparatus 100 according to the first embodiment when viewed from above.

FIG. 4 is a view showing a light source unit 110 according to the first embodiment.

FIG. 5 is a view of a color separating-combining unit 140 and a projection unit 150 according to the first embodiment.

FIG. 6 is a view showing a ceiling plate 240 according to the first embodiment.

FIG. 7 is a view showing a ceiling plate 240 according to the first embodiment.

FIG. 8 is a view showing a ceiling plate 240 according to the first embodiment.

FIG. 9 is a view showing a projection-plane-side shield plate 800 according to the first embodiment.

FIG. 10 is a diagram illustrating unwanted-light shielding according to the first embodiment.

FIG. 11 is a diagram illustrating the unwanted-light shielding according to the first embodiment.

FIG. 12 is a diagram illustrating the unwanted-light shielding according to the first embodiment.

FIG. 13 is a view showing a projection-plane-side shield plate 800 according to Modification 1.

FIG. 14 is a view showing a projection-plane-side shield plate 800 according to Modification 1.

FIG. 15 is a view showing a projection-plane-side shield plate 800 according to Modification 1.

FIG. 16 is a diagram illustrating unwanted-light shielding according to Modification 1.

FIG. 17 is a view showing a projection-plane-side shield plate 800 according to Modification 2.

FIG. 18 is a view showing a projection-plane-side shield plate 800 according to Modification 2.

FIG. 19 is a view showing a projection-plane-side shield plate 800 according to Modification 2.

FIG. 20 is a perspective view showing a projection display apparatus 100 according to Modification 3.

FIG. 21 is a perspective view showing a projection display apparatus 100 according to Modification 4.

FIG. 22 is a view of a projection display apparatus 100 according to a second embodiment when viewed from side.

FIG. 23 is a view showing a first configuration example according to a third embodiment.

FIG. 24 is a view showing a support mechanism 900 of the first configuration example according to the third embodiment.

FIG. 25 is a view showing the support mechanism 900 of the first configuration example according to the third embodiment.

FIG. 26 is a view showing the support mechanism 900 of the first configuration example according to the third embodiment.

FIG. 27 is a view showing the support mechanism 900 of the first configuration example according to the third embodiment.

FIG. 28 is a view showing the support mechanism 900 of the first configuration example according to the third embodiment.

FIG. 29 is a view showing a second configuration example according to the third embodiment.

FIG. 30 is a view showing a support mechanism 900 of the second configuration example according to the third embodiment.

FIG. 31 is a view showing the support mechanism 900 of the second configuration example according to the third embodiment.

FIG. 32 is a view showing the support mechanism 900 of the second configuration example according to the third embodiment.

FIG. 33 is a view showing the support mechanism 900 of the second configuration example according to the third embodiment.

### DETAILED DESCRIPTION OF THE EMBODIMENTS

Hereinafter, a projection display apparatus according to embodiments of the present invention will be described with reference to the drawings. In the following description of the drawings, the same or similar reference signs are attached to the same or similar units and portions.

It should be noted that the drawings are schematic and ratios of dimensions and the like are different from actual ones. Therefore, specific dimensions and the like should be determined in consideration of the following description. Moreover, it is needless to say that the drawings also include portions having different dimensional relationships and ratios from each other.

### Overview of Embodiments

A projection display apparatus of first aspect includes a housing case housing a light source; a reflective light valve configured to modulate light emitted from the light source; and a projection unit configured to project light emitted from the reflective light valve on a projection plane. The projection display apparatus is placed along a first placement face substantially parallel to the projection plane and along a second placement face substantially orthogonal to the first placement face. The housing case has a base plate and a ceiling plate, the base plate facing the second placement face, the ceiling plate being provided on an opposite side to the base plate. The ceiling plate is provided with a transmission area and a projection-plane-side shield plate. The transmission area is an area through which light emitted from the projection unit passes. The projection-plane-side shield plate is placed closer to the projection plane than the transmission area. The projection-plane-side shield plate is configured to shield unwanted light being other than light forming an image among light passed through the transmission area.

In the embodiments, the ceiling plate is provided with the projection-plane-side shield plate placed closer to the projection plane than the transmission area. The projection-plane-side shield plate is configured to shield light other than that forming an image, namely unwanted light, among light that has passed through the transmission area. In other words, near the projection plane where an image plane is formed, the projection-plane-side shield plate shields unwanted light. Accordingly, unwanted light reflected by the reflective light valve can be removed sufficiently, compared to the case where the unwanted light is shielded by an aperture placed near the reflective light valve in which an object plane is formed.

### First Embodiment

### (Configuration of Projection Display Apparatus)

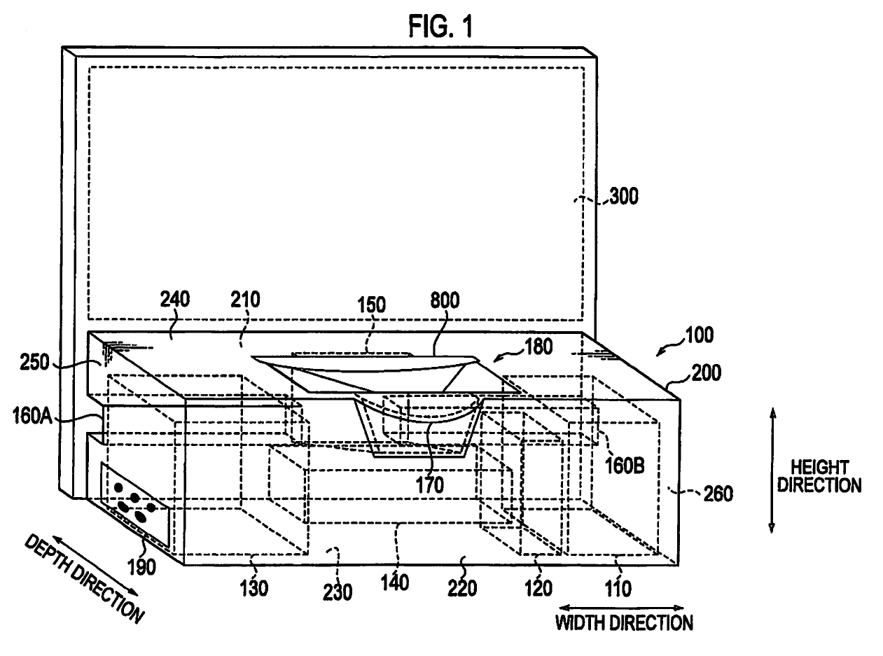

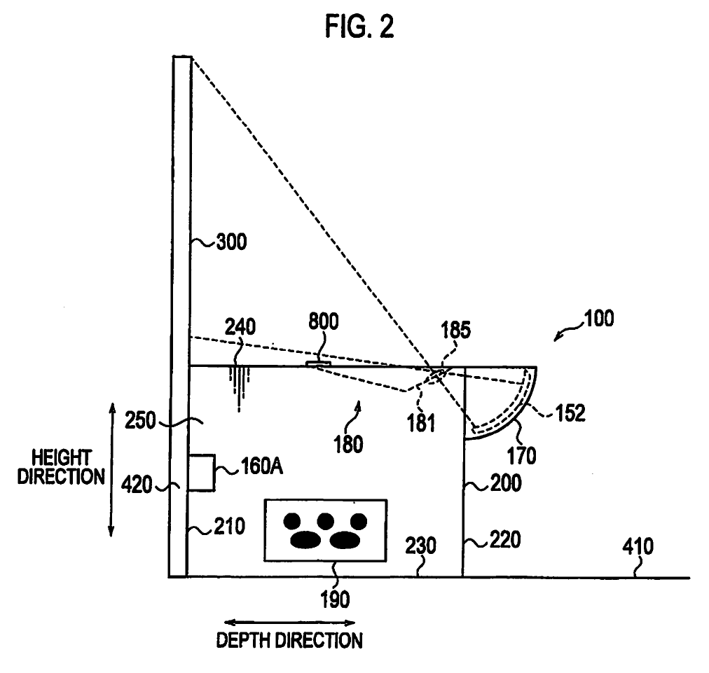

Hereinafter, a configuration of a projection display apparatus according to a first embodiment will be described with reference to FIGS. 1 and 2. FIG. 1 is a perspective view of a projection display apparatus 100 according to the first embodiment. FIG. 2 is a view of the projection display apparatus 100 according to the first embodiment when viewed from side.

As shown in FIGS. 1 and 2, the projection display apparatus 100 includes a housing case 200 and is configured to project an image on a projection plane 300. The projection display apparatus 100 is arranged along a first placement surface (a wall surface 420 shown in FIG. 2) and a second placement surface (a floor surface 410 shown in FIG. 2) substantially orthogonal to the first placement surface.

Here, the first embodiment is illustrated for a case where the projection display apparatus 100 projects image light on the projection plane 300 provided on a wall surface (wall surface projection). An arrangement of the housing case 200 in this case is referred to as a wall surface projection arrangement. In the first embodiment, the first placement surface substantially parallel to the projection plane 300 is the wall surface 420.

In the first embodiment, a horizontal direction parallel to the projection plane 300 is referred to as “a width direction”, a orthogonal direction to the projection plane 300 is referred to as “a depth direction”, and an orthogonal direction to both of the width direction and the depth direction is referred to as “a height direction”.

The housing case 200 has a substantially rectangular parallelepiped shape. The size of the housing case 200 in the depth direction and the size of the housing case 200 in the height direction are smaller than the size of the housing case 200 in the width direction. The size of the housing case 200 in the depth direction is almost equal to a projection distance from a reflection mirror (a concave mirror 152 shown in FIG. 2) to the projection plane 300. In the width direction, the size of the housing case 200 is almost equal to the size of the projection plane 300. In the height direction, the size of the housing case 200 is determined depending on a position where the projection plane 300 is provided.

Specifically, the housing case 200 includes a projection-plane-side sidewall 210, a front-side sidewall 220, a base plate 230, a ceiling plate 240, a first-lateral-surface-side sidewall 250, and a second-lateral-surface-side sidewall 260.

The projection-plane-side sidewall 210 is a plate-shaped member facing the first placement surface (the wall surface 420 in the first embodiment) substantially parallel to the projection plane 300. The front-side sidewall 220 is a plate-shaped member provided on the side opposite from the projection-plane-side sidewall 210. The base plate 230 is a plate-shaped member facing the second placement surface (a floor surface 410 in the first embodiment) other than the first placement surface substantially parallel to the projection plane 300. The ceiling plate 240 is a plate-shaped member provided on the side opposite from the base plate 230. The first-lateral-surface-side sidewall 250 and the second-lateral-surface-side sidewall 260 are plate-shaped members forming both ends of the housing case 200 in the width direction.

The housing case 200 houses a light source unit 110, a power supply unit 120, a cooling unit 130, a color separating-combining unit 140, a projection unit 150. The projection-plane-side sidewall 210 includes a projection-plane-side recessed portion 160A and projection-plane-side recessed portion 160B. The front-side sidewall 220 includes front-side protruding portion 170. The ceiling plate 240 includes a ceiling-plate recessed portion 180 and a projection-plane-side shield plate 800. The first-lateral-surface-side sidewall 250 includes cable terminals 190.

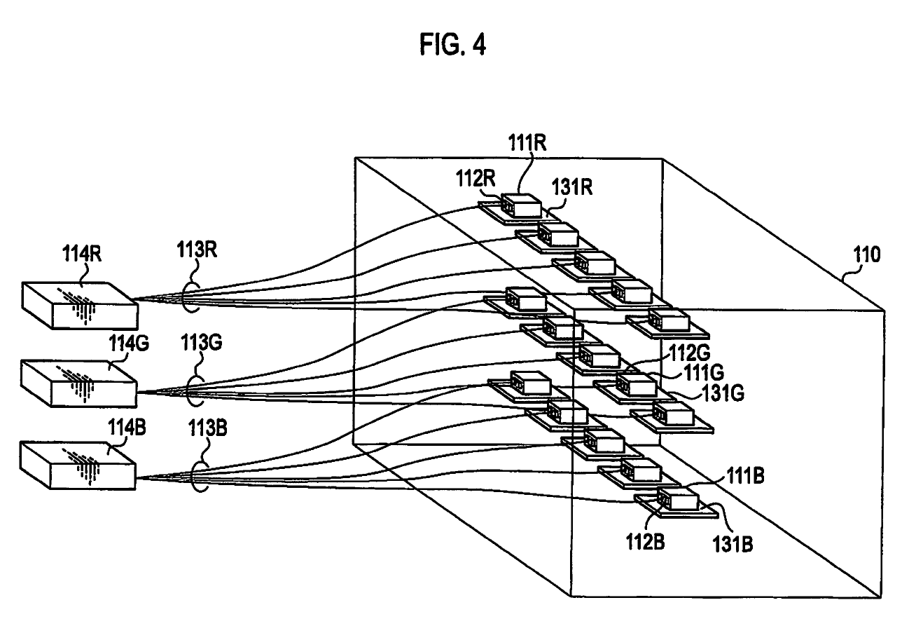

The light source unit 110 is a unit including multiple solid light sources (solid light sources 111 shown in FIG. 4). Each of the solid light sources 111 is a light source such as a laser diode (LD). In the first embodiment, the light source unit 110 includes red solid light sources (red solid light sources 111R shown in FIG. 4) configured to emit red component light R, green solid light sources (green solid light sources 111G shown in FIG. 4) configured to emit green component light G, and blue solid light sources (blue solid light sources 111B shown in FIG. 4) configured to emit blue component light B. The light source unit 110 will be described in detail below (see FIG. 4).

The power supply unit 120 is a unit to supply power to the projection display apparatus 100. The power supply unit 120 supplies power to the light source unit 110 and the cooling unit 130, for example.

The cooling unit 130 is a unit to cool the multiple solid light sources provided in the light source unit 110. Specifically, the cooling unit 130 cools each of the solid light sources by cooling jackets (cooling jackets 131 shown in FIG. 4) on which the solid light source is mounted.

The cooling unit 130 may be configured to cool the power supply unit 120 and a light valve (DMDs 500 which will be described later) in addition of the solid light sources.

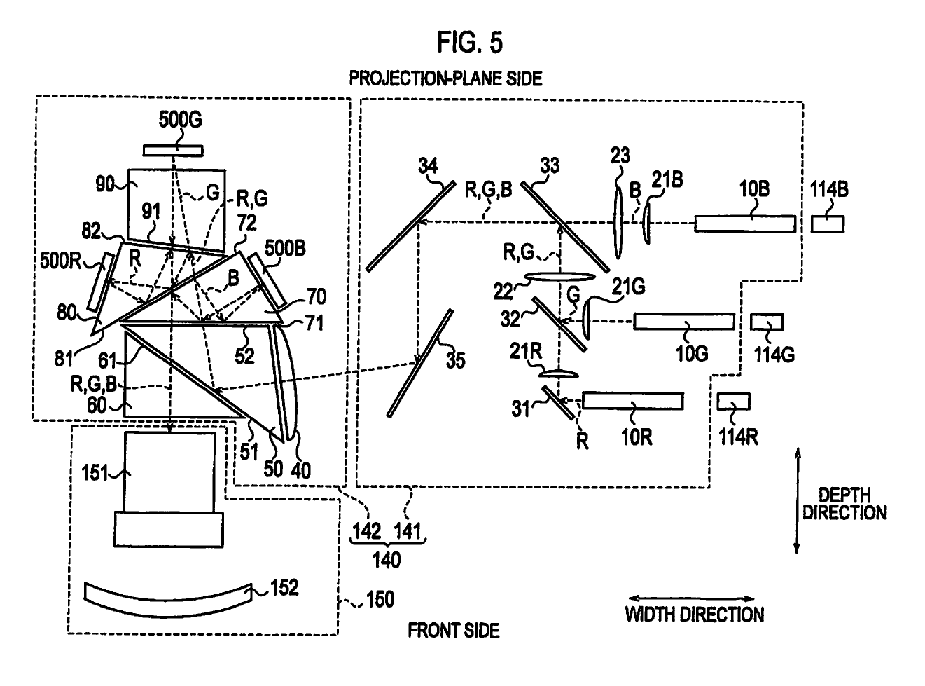

The color separating-combining unit 140 combines the red component light R emitted from the red solid light sources, the green component light G emitted from the green solid light sources, and the blue component light B emitted from the blue solid light sources. In addition, the color separating-combining unit 140 separates combined light including the red component light R, the green component light G, and the blue component light B, and modulates the red component light R, the green component light G, and the blue component light B. Moreover, the color separating-combining unit 140 recombines the red component light R, the green component light G, and the blue component light B, and thereby emits image light to the projection unit 150. The color separating-combining unit 140 will be described in detail later (see FIG. 5).

The projection unit 150 projects the light (image light) outputted from the color separating-combining unit 140 on the projection plane 300. Specifically, the projection unit 150 includes a projection lens group (a projection lens group 151 shown in FIG. 5) configured to project the light outputted from the color separating-combining unit 140 on the projection plane 300, and a reflection mirror (a concave mirror 152 shown in FIG. 5) configured to reflect the light, outputted from the projection lens group, to the projection plane 300. The projection unit 150 will be described in detail later.

The projection-plane-side recessed portion 160A and the projection-plane-side recessed portion 160B are provided in the projection-plane-side sidewall 210, and each have a shape recessed inward of the housing case 200. The projection-plane-side recessed portion 160A and the projection-plane-side recessed portion 160B extend to the respective ends of the housing case 200. The projection-plane-side recessed portion 160A and the projection-plane-side recessed portion 160B are each provided with a vent hole through which the inside and the outside of the housing case 200 are in communication with each other.

In the first embodiment, the projection-plane-side recessed portion 160A and the projection-plane-side recessed portion 160B extend in the width direction of the housing case 200. For example, the projection-plane-side recessed portion 160A is provided with an air inlet as the vent hole for allowing the air outside the housing case 200 to flow into the inside of the housing case 200. The projection-plane-side recessed portion 160B is provided with an air outlet as the vent hole for allowing the air inside the housing case 200 to flow out into the outside of the housing case 200.

The front-side protruding portion 170 is provided in the front-side sidewall 220, and has a shape protruding to the outside of the housing case 200. The front-side protruding portion 170 is provided at a substantially center portion of the front-side sidewall 220 in the width direction of the housing case 200. A space formed by the front-side protruding portion 170 inside the housing case 200 is used for placing the projection unit 150 (the concave mirror 152 shown in FIG. 5).

The ceiling-plate recessed portion 180 is provided in the ceiling plate 240, and has a shape recessed inward of the housing case 200. The ceiling-plate recessed portion 180 includes an inclined surface 181 extending downwardly toward the projection plane 300. The inclined surface 181 has a transmission area 185 through which light outputted from the projection unit 150 is transmitted (projected) toward the projection plane 300.

The projection-plane-side shield plate 800 is provided on the ceiling plate 240, at a position closer to the projection plane 300 than the transmission area 185. The projection-plane-side shield plate 800 has a shape extending in the horizontal direction parallel to the projection plane 300 (in the width direction of the housing case 200).

The cable terminals 190 are provided to the first-lateral-surface-side sidewall 250, and are terminals such as a power supply terminal and an image signal terminal. Here, the cable terminals 190 may be provided to the second-lateral-surface-side sidewall 260.

### (Arrangement of Units in Housing Case in Width Direction)

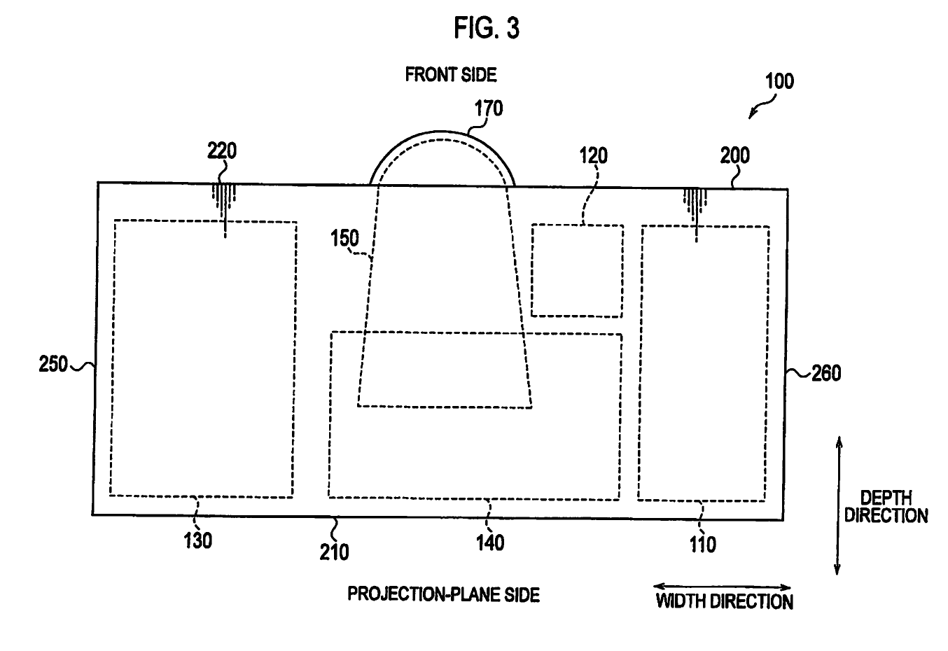

Hereinafter, arrangement of the units in the width direction in the first embodiment will be described with reference to FIG. 3. FIG. 3 is a view of the projection display apparatus 100 according to the first embodiment when viewed from above.

As shown in FIG. 3, the projection unit 150 is arranged in a substantially center of the housing case 200 in a horizontal direction parallel to the projection plane 300 (in the width direction of the housing case 200).

The light source unit 110 and the cooling unit 130 are arranged in the line with the projection unit 150 in the width direction of the housing case 200. Specifically, the light source unit 110 is arranged in the line at one of the sides of the projection unit 150 in the width direction of the housing case 200 (the side extending toward the second-lateral-surface-side sidewall 260). The cooling unit 130 is arranged in the line at the other side of the projection unit 150 in the width direction of the housing case 200 (the side extending to the first-lateral-surface-side sidewall 250).

The power supply unit 120 is arranged in the line, with the projection unit 150 in the width direction of the housing case 200. Specifically, the power supply unit 120 is arranged in the line at the same side of the projection unit 150 as the light source unit 110 in the width direction of the housing case 200. The power supply unit 120 is preferably arranged between the projection unit 150 and the light source unit 110.

### (Configuration of Light Source Unit)

Hereinafter, a configuration of the light source unit according to the first embodiment will be described with reference to FIG. 4. FIG. 4 is a view showing the light source unit 110 according to the first embodiment.

As shown in FIG. 4, the light source unit 110 includes multiple red solid light sources 111R, multiple green solid light sources 111G and multiple blue solid light sources 111B.

The red solid light sources 111R are red solid light sources, such as LDs, configured to emit red component light R as described above. Each of the red solid light sources 111R includes a head 112R to which an optical fiber 113R is connected.

The optical fibers 113R connected to the respective heads 112R of the red solid light sources 111R are bundled by a bundle unit 114R. In other words, the light beams emitted from the respective red solid light sources 111R are transmitted through the optical fibers 113R, and thus are gathered into the bundle unit 114R.

The red solid light sources 111R are mounted on respective cooling jackets 131R. For example, the red solid light sources 111R are fixed to respective cooling jackets 131R by screwing. The red solid light sources 111R are cooled by respective cooling jackets 131R.

The green solid light sources 111G are green solid light sources, such as LDs, configured to emit green component light G as described above. Each of the green solid light sources 111G includes a head 112G to which an optical fiber 113G is connected.

The optical fibers 113G connected to the respective heads 112G of the green solid light sources 111G are bundled by a bundle unit 114G. In other words, the light beams emitted from all the green solid light sources 111G are transmitted through the optical fibers 113G, and thus are gathered into the bundle unit 114G.

The green solid light sources 111G are mounted on respective cooling jackets 131G. For example, the green solid light sources 111G are fixed to respective cooling jackets 131G by screwing. The green solid light sources 111G are cooled by respective cooling jackets 131G.

The blue solid light sources 111B are blue solid light sources, such as LDs, configured to emit blue component light B as described above. Each of the blue solid light sources 111B includes a head 112B to which an optical fiber 113B is connected.

The optical fibers 113B connected to the respective heads 112B of the blue solid light sources 111B are bundled by a bundle unit 114B. In other words, the light beams emitted from all the blue solid light sources 111B are transmitted through the optical fibers 113B, and thus are gathered into the bundle unit 114B.

The blue solid light sources 111B are mounted on respective cooling jackets 131B. For example, the blue solid light sources 111B are fixed to respective cooling jackets 131B by screwing. The blue solid light sources 111B are cooled by respective cooling jackets 131B.

### (Configurations of Color Separating-Combining Unit and Projection Unit)

Hereinafter, configurations of the color separating-combining unit and the projection unit according to the first embodiment will be described with reference to FIG. 5. FIG. 5 is a view showing the color separating-combining unit 140 and the projection unit 150 according to the first embodiment. The projection display apparatus 100 based on the DLP (Digital Light Processing) technology (registered trademark) is illustrated in the first embodiment.

As shown in FIG. 5, the color separating-combining unit 140 includes a first unit 141 and a second unit 142.

The first unit 141 is configured to combine the red component light R, the green component light G, and the blue component light B, and to output the combine light including the red component light R, the green component light G, and the blue component light B to the second unit 142.

Specifically, the first unit 141 includes multiple rod integrators (a rod integrator 10R, a rod integrator 10G, and a rod integrator 10B), a lens group (a lens 21R, a lens 21G, a lens 21B, a lens 22, and a lens 23), and a mirror group (a mirror 31, a mirror 32, a mirror 33, a mirror 34, and a mirror 35).

The rod integrator 1OR includes a light incident surface, a light output surface, and a light reflection side surface provided between an outer circumference of the light incident surface and an outer circumference of the light output surface. The rod integrator 10R uniformizes the red component light R outputted from the optical fibers 113R bundled by the bundle unit 114R. More specifically, the rod integrator 10R makes the red component light R uniform by reflecting the red component light R with the light reflection side surface.

The rod integrator 10G includes a light incident surface, a light output surface, and a light reflection side surface provided between an outer circumference of the light incident surface and an outer circumference of the light output surface. The rod integrator 10G uniformizes the green component light G outputted from the optical fibers 113G bundled by the bundle unit 114G. More specifically, the rod integrator 10G makes the green component light G uniform by reflecting the green component light G with the light reflection side surface.

The rod integrator 10B includes a light incident surface, a light output surface, and a light reflection side surface provided between an outer circumference of the light incident surface and an outer circumference of the light output surface. The rod integrator 10B uniformizes the blue component light B outputted from the optical fibers 113B bundled by the bundle unit 114B. More specifically, the rod integrator 10B makes the blue component light B uniform by reflecting the blue component light B with the light reflection side surface.

Incidentally, each of the rod integrator 10R, the rod integrator 10G, and the rod integrator 10B may be a hollow rod including a mirror surface as the light reflection side surface. Instead, each of the rod integrator 10R, the rod integrator 10G, and the rod integrator 10B may be a solid rod formed of a glass.

Here, each of the rod integrator 10R, the rod integrator 10G, and the rod integrator 10B has a columnar shape extending in a horizontal direction substantially parallel to the projection plane 300 (in the width direction of the housing case 200). In other words, the rod integrator 10R is arranged so that the longitudinal direction of the rod integrator 10R can extend substantially in the width direction of the housing case 200. Similarly, the rod integrator 10G and the rod integrator 10B are arranged so that the respective longitudinal directions of the rod integrator 10G and the rod integrator 10B can extend substantially in the width direction of the housing case 200. The rod integrator 10R, the rod integrator 10G, and the rod integrator 10B are arranged in the line on a single horizontal plane substantially orthogonal to the projection plane 300 (a plane parallel to the ceiling plate 240).

The lens 21R is a lens configured to make the red component light R substantially parallel so that the substantially parallel red component light R can enter a DMD 500R. The lens 21G is a lens configured to make the green component light G substantially parallel so that the substantially parallel green component light G can enter a DMD 500G. The lens 21B is a lens configured to make the blue component light B substantially parallel so that the substantially parallel blue component light B can enter onto a DMD 500B.

The lens 22 is a lens configured to cause the red component light and the green component light G to substantially form images on the DMD 500R and the DMD 500G, respectively, while controlling the expansion of the red component light R and the green component light G. The lens 23 is a lens configured to cause the blue component light B to substantially form an image on the DMD 500B while controlling the expansion of the blue component light B.

The mirror 31 reflects the red component light R outputted from the rod integrator 10R. The mirror 32 is a dichroic mirror configured to reflect the green component light G outputted from the rod integrator 10G, and to transmit the red component light R. The mirror 33 is a dichroic mirror configured to transmit the blue component light B outputted from the rod integrator 10B, and to reflect the red component light R and the green component light G.

The mirror 34 reflects the red component light R, the green component light G, and the blue component light B. The mirror 35 reflects the red component light R, the green component light G, and the blue component light B to the second unit 142. Here, FIG. 5 shows the configurations in a plan view for simplification of the description; however, the mirror 35 actually reflects the red component light R, the green component light G, and the blue component light B obliquely in the height direction.

The second unit 142 separates the red component light R, the green component light G, and the blue component light B from each other, and modulates the red component light R, the green component light G, and the blue component light B. Subsequently, the second unit 142 recombines the red component light R, the green component light G, and the blue component light B, and outputs the image light to the projection unit 150.

Specifically, the second unit 142 includes a lens 40, a prism 50, a prism 60, a prism 70, a prism 80, a prism 90, and multiple digital micromirror devices (DMDs: a DMD 500R, a DMD 500G and a DMD 500B).

The lens 40 is a lens configured to make the light outputted from the first unit 141 substantially parallel so that the substantially parallel light of each color component can enter the DMD of the same color.

The prism 50 is made of a light transmissive material, and includes a surface 51 and a surface 52. An air gap is provided between the prism 50 (the surface 51) and the prism 60 (a surface 61), and an angel (incident angle) at which the light outputted from the first unit 141 enters the surface 51 is larger than a total reflection angle. For this reason, the light outputted from the first unit 141 is reflected by the surface 51. On the other hand, an air gap is also provided between the prism 50 (the surface 52) and the prism 70 (a surface 71), and an angel (incident angle) at which the light outputted from the first unit 141 enters the surface 52 is smaller than the total reflection angle. Thus, the light reflected by the surface 51 passes through the surface 52.

The prism 60 is made of a light transmissive material, and includes the surface 61.

The prism 70 is made of a light transmissive material, and includes a surface 71 and a surface 72. An air gap is provided between the prism 50 (the surface 52) and the prism 70 (the surface 71), and an angle (incident angle) at which each of the blue component light B reflected by the surface 72 and the blue component light B outputted from the DMD 500B enters the surface 71 is larger than the total reflection angle. Accordingly, the blue component light B reflected by the surface 72 and the blue component light B outputted from the DMD 500B are reflected by the surface 71.

The surface 72 is a dichroic mirror surface configured to transmit the red component light R and the green component light G and to reflect the blue component light B. Thus, in the light reflected by the surface 51, the red component light R and the green component light G pass through the surface 72, but the blue component light B is reflected by the surface 72. The blue component light B reflected by the surface 71 is again reflected by the surface 72.

The prism 80 is made of a light transmissive material, and includes a surface 81 and a surface 82. An air gap is provided between the prism 70 (the surface 72) and the prism 80 (the surface 81). Since an angle (incident angle) at which each of the red component light R passing through the surface 81 and then reflected by the surface 82, and the red component light R outputted from the DMD 500R again enters the surface 81 is larger than the total reflection angle, the red component light R passing through the surface 81 and then reflected by the surface 82, and the red component light R outputted from the DMD 500R are reflected by the surface 81. On the other hand, since an angle (incident angle) at which the red component light R outputted from the DMD 500R, reflected by the surface 81, and then reflected by the surface 82 again enters the surface 81 is smaller than the total reflection angle, the red component light R outputted from the DMD 500R, reflected by the surface 81, and then reflected by the surface 82 passes through the surface 81.

The surface 82 is a dichroic mirror surface configured to transmit the green component light G and to reflect the red component light R. Hence, in the light passing through the surface 81, the green component light G passes through the surface 82, whereas the red component light R is reflected by the surface 82. The red component light R reflected by the surface 81 is reflected by the surface 82. The green component light G outputted from the DMD 500G passes through the surface 82.

Here, the prism 70 separates the blue component light B from the combine light including the red component light R and the green component light G by means of the surface 72. The prism 80 separates the red component light R and the green component light G from each other by means of the surface 82. In short, the prism 70 and the prism 80 function as a color separation element to separate the color component light by colors.

Note that, in the first embodiment, a cut-off wavelength of the surface 72 of the prism 70 is set at a value between a wavelength range corresponding to a green color and a wavelength range corresponding to a blue color. In addition, a cut-off wavelength of the surface 82 of the prism 80 is set at a value between a wavelength range corresponding to a red color and the wavelength range corresponding to the green color.

Meanwhile, the prism 70 combines the blue component light B and the combine light including the red component light R and the green component light G by means of the surface 72. The prism 80 combines the red component light R and the green component light G by means of the surface 82. In short, the prism 70 and the prism 80 function as a color combining element to combine color component light of all the colors.

The prism 90 is made of a light transmissive material, and includes a surface 91. The surface 91 is configured to transmit the green component light G. Here, the green component light G entering the DMD 500G and the green component light G outputted from the DMD 500G pass through the surface 91.

The DMD 500R, the DMD 500G and the DMD 500B are each formed of multiple movable micromirrors. Each of the micromirrors corresponds to one pixel, basically. The DMD 500R changes the angle of each micromirror to switch whether or not to reflect the red component light R toward the projection unit 150. Similarly, the DMD 500G and the DMD 500B change the angle of each micromirror to switch whether or not to reflect the green component light G and the blue component light B toward the projection unit 150, respectively.

The projection unit 150 includes a projection lens group 151 and a concave mirror 152.

The projection lens group 151 outputs the light (image light) outputted from the color separating-combining unit 140 to the concave mirror 152.

The concave mirror 152 reflects the light (image light) outputted from the projection lens group 151. The concave mirror 152 collects the image light, and then scatters the image light over a wide angle. For example, the concave mirror 152 is an aspherical mirror having a surface concave toward the projection lens group 151.

The image light collected by the concave mirror 152 passes through the transmission area provided in the inclined surface 181 of the ceiling-plate recessed portion 180 formed in the ceiling plate 240. The transmission area provided in the inclined surface 181 is preferably provided near a place where the image light is collected by the concave mirror 152.

The concave mirror 152 is housed in the space formed by the front-side protruding portion 170, as described above. For example, the concave mirror 152 is preferably fixed to the inside of the front-side protruding portion 170. In addition, the inner surface of the front-side protruding portion 170 preferably has a shape along the concave mirror 152.

### (Configuration of the Ceiling Plate)

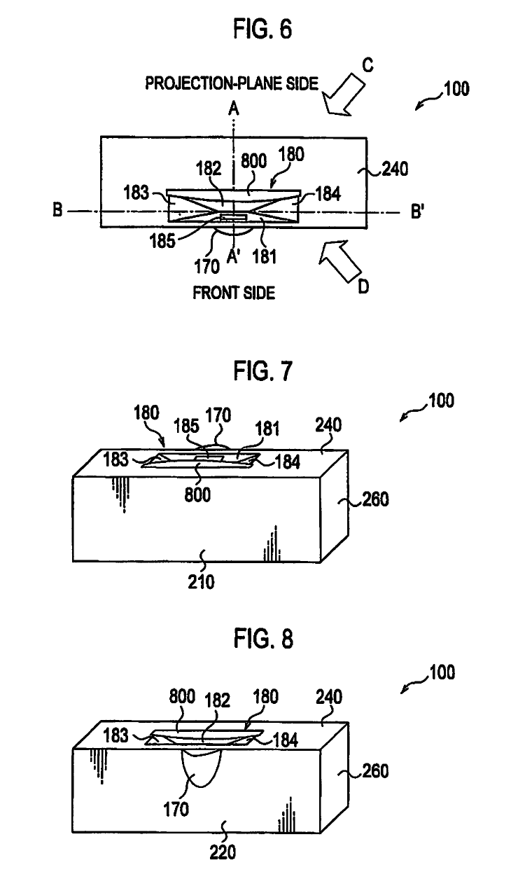

Hereinafter, a configuration of the ceiling plate according to the first embodiment will be described with reference drawings. FIGS. 6 to 8 are views each showing the ceiling plate 240 according to the first embodiment.

Specifically, FIG. 6 is a view of the projection display apparatus 100 seen from the ceiling plate 240 side. FIG. 7 is a view of the projection display apparatus 100 seen in a direction C in FIG. 6. FIG. 8 is a view of the projection display apparatus 100 seen in a direction D in FIG. 6.

As FIGS. 6 to 8 show, the ceiling plate 240 is provided with the ceiling-plate recessed portion 180. In addition to the inclined surface 181 described above, the ceiling-plate recessed portion 180 has an inclined surface 182, an inclined surface 183, and an inclined surface 184.

The inclined surface 181 is provided on the front side of the ceiling-plate recessed portion 180, and has a shape inclining downward toward the projection plane 300. As described above, the inclined surface 181 is provided with the transmission area 185 through which light emitted from the projection unit 150 passes toward the projection plane 300.

The inclined surface 182 is provided on the projection plane 300 side of the ceiling-plate recessed portion 180, and has a shape inclining downward toward the front side.

The inclined surface 183 and the inclined surface 184 are provided respectively on both sides of the ceiling-plate recessed portion 180 in the width direction of the housing case 200. The inclined surface 183 and the inclined surface 184 each have a shape inclining toward the center of the ceiling-plate recessed portion 180.

The projection-plane-side shield plate 800 is placed closer to the projection plane 300 than the transmission area 185. Specifically, the projection-plane-side shield plate 800 has a curved shape bulging over the inclined surface 182. The projection-plane-side shield plate 800 is formed of a shielding member, and is configured to shield light other than that forming an image, namely unwanted light, among light that has passed through the transmission area 185.

### (Configuration of the Projection-Plane-Side Shield Plate)

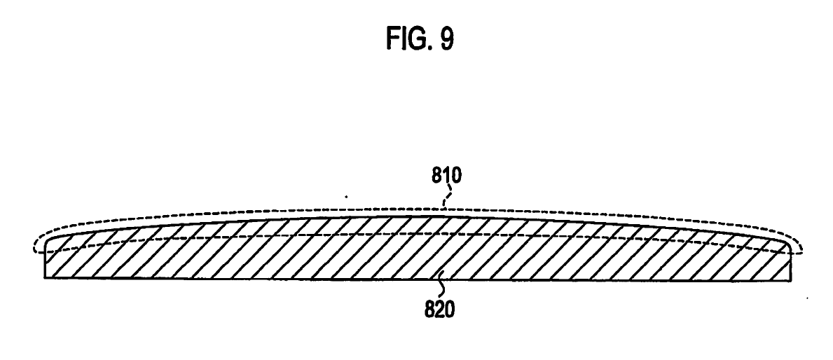

Hereinafter, a projection-plane-side shield plate according to the first embodiment will be described with reference to the drawing. FIG. 9 is a view showing the projection-plane-side shield plate 800 according to the first embodiment.

As FIG. 9 shows, the projection-plane-side shield plate 800 has a curved portion 810. As described above, the projection-plane-side shield plate 800 is placed such that the curved portion 810 may bulge over the inclined surface 182. The entire projection-plane-side shield plate 800 is formed of a shielding member 820. For example, the shielding member 820 is a black sheet metal or a black acrylic sheet.

### (Shielding of Unwanted Light)

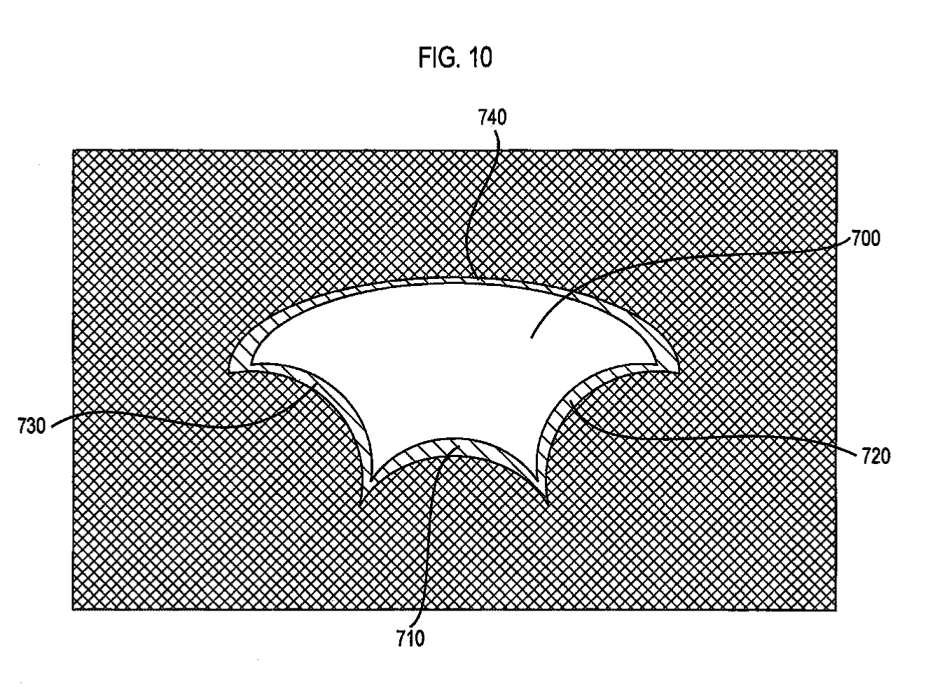

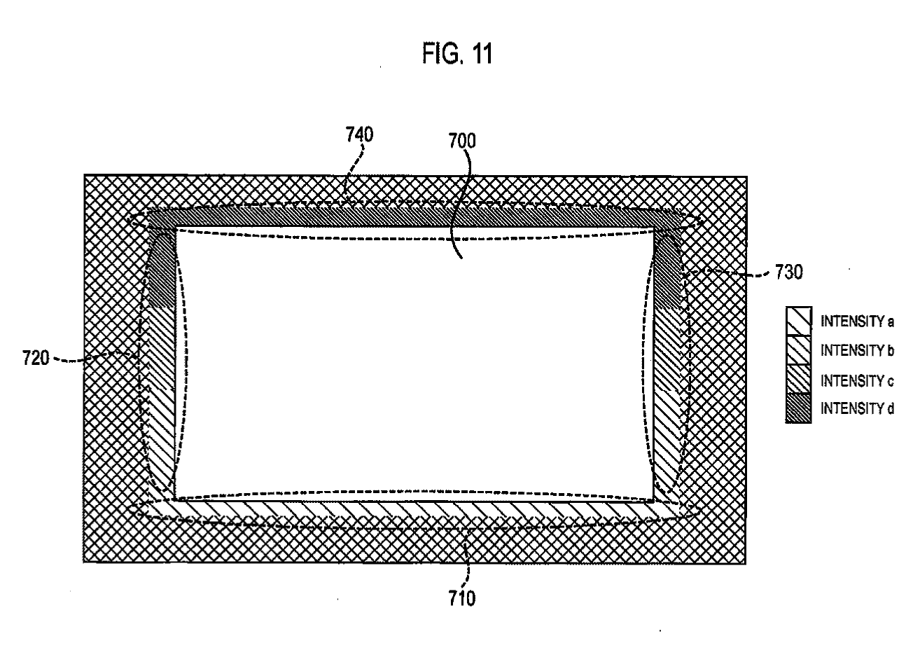

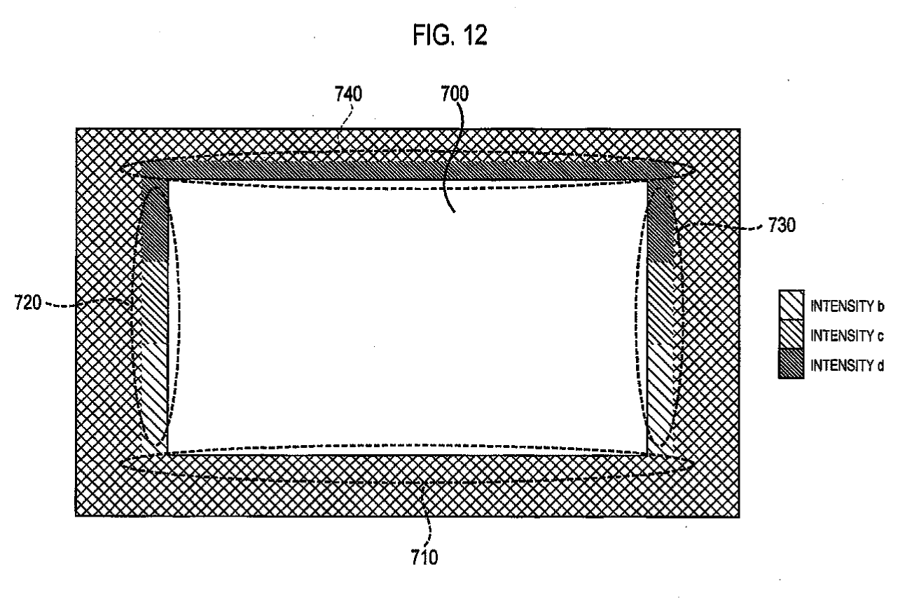

Hereinafter, a shielding of unwanted light according to the first embodiment will be described with reference to the drawings. FIG. 10 is a diagram showing a luminous flux pattern of image light 700 near the concave mirror 152 according to the first embodiment. FIGS. 11 and 12 are diagrams each showing a luminous flux pattern of the image light 700 on the projection plane 300 according to the first embodiment.

Note that, since the concave mirror 152 and the projection plane 300 face each other, the luminous flux pattern of the image light 700 on the projection plane 300 (see FIGS. 11 and 12) and the luminous flux pattern of the image light 700 near the concave mirror 152 (see FIG. 10) are mirror-reversed.

First, referring to FIG. 10, a description is given of the luminance flux pattern of the image light 700 near the concave mirror 152. In the projection display apparatus 100 according to the embodiment, an aspheric mirror is used as the concave mirror 152. Accordingly, as FIG. 10 shows, the image light 700 forming an image forms a distorted pattern near the concave mirror 152.

A lower edge of the image light 700 curves upward. Unwanted light 710 exists along the lower edge of the image light 700. Side edges of the image light 700 curve inward, and expand upward. Unwanted light 720 and unwanted light 730 exist along the respective side edges of the image light 700. An upper edge of the image light 700 curves upward. Unwanted light 740 exists along the upper edge of the image light 700.

In the projection display apparatus 100 according to the embodiment, to reduce the distance between the concave mirror 152 and the projection plane 300, the DMD 500 is placed such that the center of the DMD 500 is shifted upward of the center of the optical axis of the projection lens group 151. It is known that the intensity of light passing near the center of the optical axis of the projection lens group 151 is larger than the intensity of light passing through a peripheral area of the projection lens group 151.

For that reason, it should be noted that, in the luminance flux pattern of the light image 700 near the concave mirror 152, the intensity of light at a lower part of the pattern is larger than that at an upper part of the pattern. In other words, the unwanted light 710 has a larger intensity than the unwanted light 740.

Second, referring to FIG. 11, a description is given of the luminous flux pattern of the image light 700 on the projection plane 300. Note that FIG. 11 shows a case where the projection-plane-side shield plate 800 is not provided.

As FIG. 11 shows, the image light 700 has a rectangular shape on the projection plane 300. The unwanted light 710, the unwanted light 720, the unwanted light 730, and the unwanted light 740 exist around the image light 700. Here, the unwanted light includes light with an intensity a, light with an intensity b, light with an intensity c, and light with intensity d, from the lower part to the upper part. Here, the intensities a, b, c, and d satisfy the following relationship: intensity a>intensity b>intensity c>intensity d. In other words, the intensity of the unwanted light decreases gradually from the lower part of the image light 700 to the upper part of the image light 700. Note that the unwanted light 710 includes an area having the intensity a which is the largest.

Third, referring to FIG. 12, a description is given of a pattern formed on the projection plane 300 by light projected from the projection display apparatus 100. Note that FIG. 12 shows a case where the projection-plane-side shield plate 800 is provided.

As FIG. 12 shows, the unwanted light 710 existing along the lower edge of the image light 700 is shielded. Since the projection-plane-side shield plate 800 is placed near the projection plane 300, the unwanted light 710 can be removed sufficiently by being shielded by the projection-plane-side shield plate 800. In other words, light having the intensity a, which is the largest, is removed.

### (Advantageous Effects)

In the first embodiment, the ceiling plate 240 is provided with the projection-plane-side shield plate 800 which is placed closer to the projection plane 300 than the transmission area 185. The projection-plane-side shield plate 800 is configured to shield light other than that forming an image, namely unwanted light (unwanted light 710), among light that has passed through the transmission area 185.

The projection plane 300, in which an image plane is formed, is much larger than the reflective light valve (DMD 500) placed at an object plane of the projection lens group 151. An aperture placed near a reflective light valve (DMD 500) on which irradiation light is incident obliquely would need to have an opening larger than the reflective light valve. Accordingly, even when the projection-plane-side shield plate 800 is somewhat away from the projection plane 300, unwanted light reflected by the reflective light valve can be removed sufficiently, compared to the case where the unwanted light is shielded by the aperture placed near the reflective light valve.

It should be noted that it is effective to remove the unwanted light 710 existing along the lower edge of the image light 700 on the projection plane 300 because the unwanted light 710 is light passing near the center of the optical axis of the projection lens group 151, and therefore has an intensity larger than the other unwanted light. Moreover, it should be noted that there is less need to remove the unwanted light 740 existing along the upper edge of the image light 700 because the unwanted light 740 is light passing through a peripheral area of the projection lens group 151, and therefore has an intensity smaller than the other unwanted light.

### [Modification 1]

Modification 1 of the first embodiment will be described below with reference to the drawings. Differences from the first embodiment will be mainly described below.

Specifically, in the first embodiment, the entire projection-plane-side shield plate 800 is formed of the shielding member 820. In modification 1, on the other hand, the projection-plane-side shield plate 800 is provided with an area having a predetermined transmittance and extending in the horizontal direction parallel to the projection plane 300 (in the width direction of the housing case 200).

### (Configuration of the Projection-Plane-Side Shield Plate)

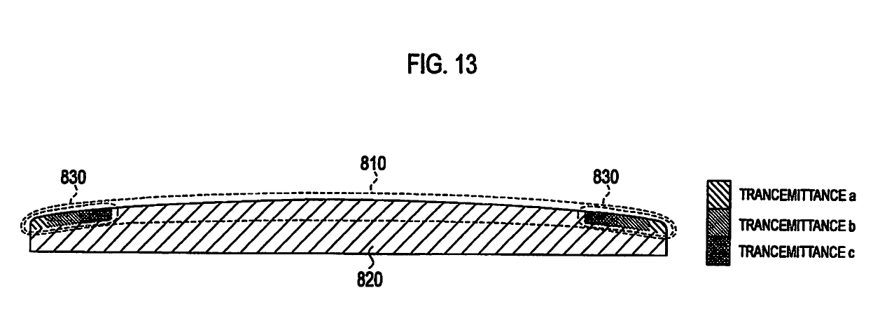

Hereinafter, a configuration of a projection-plane-side shield plate according to modification 1 will be described with reference to the drawings. FIGS. 13 to 15 are diagrams each showing a projection-plane-side shield plate 800 according to modification 1.

As FIG. 13 shows, the projection-plane-side shield plate 800 may be formed of the shielding member 820 and neutral density filters 830. The neutral density filters 830 are provided on the respective end portions of the projection-plane-side shield plate 800 in the horizontal direction parallel to the projection plane 300 (in the width direction of the housing case 200). Each of the neutral density filters 830 is a member configured to reduce the intensity of light to be transmitted, and forms an area having a predetermined transmittance. The transmittance of each shield filter 830 increases gradually toward a corresponding end of the projection-plane-side shield plate 800. Specifically, a transmittance a, a transmittance b, and a transmittance c satisfy the following relationship: transmittance a>transmittance b>transmittance c.

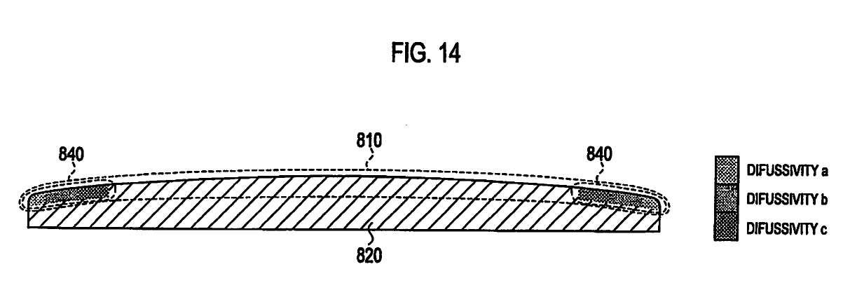

As FIG. 14 shows, the projection-plane-side shield plate 800 may be formed of the shielding member 820 and diffuser plates 840. The diffuser panels 840 are provided on the respective end portions of the projection-plane-side shield plate 800 in the horizontal direction parallel to the projection plane 300 (in the width direction of the housing case 200). Each of the diffuser plates 840 is a member configured to diffuse light, and forms an area having a predetermined transmittance. The diffusivity of each diffuser plate 840 decreases gradually toward a corresponding end of the projection-plane-side shield plate 800. Accordingly, a diffusivity a, a diffusivity b, and a diffusivity c satisfy the following relationship: diffusivity a<diffusivity b<diffusivity c.

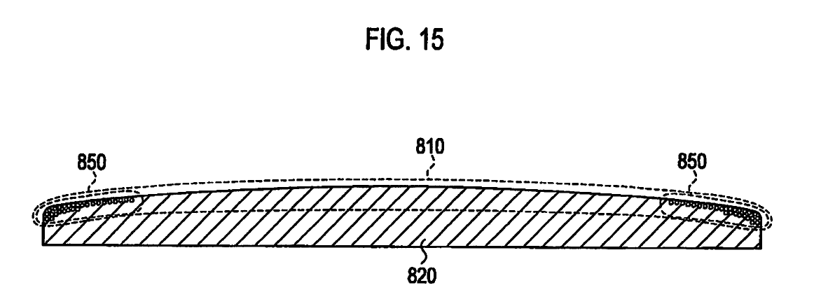

As FIG. 15 shows, the projection-plane-side shield plate 800 may be formed of the shielding member 820 having small holes 850. The small holes 850 are formed in each of its end portions of the projection-plane-side shield plate 800 in the horizontal direction parallel to the projection plane 300 (in the width direction of the housing case 200). Each small hole 850 is an aperture configured to allow light to pass through, and an area of the small hole 850 forms an area having a predetermined transmittance. The number of the small holes 850 increases toward a corresponding end of the projection-plane-side shield plate 800.

### (Shielding of Unwanted Light)

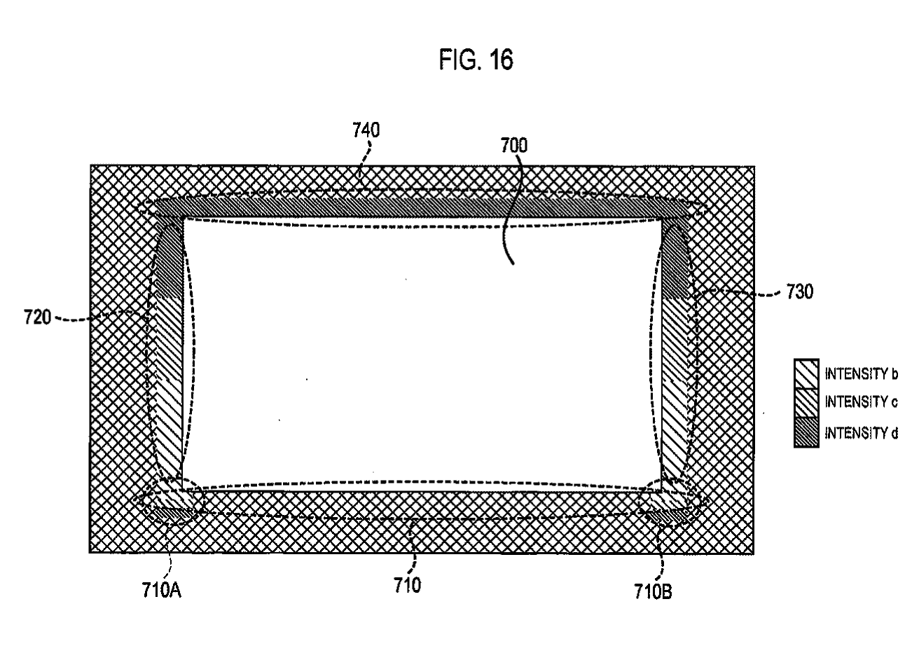

Hereinafter, a shielding of unwanted light according to modification 1 will be described with reference to the drawings. FIG. 16 is a diagram showing a luminous flux pattern of the image light 700 on the projection plane 300 according to Modification 1. Note that FIG. 16 shows a case where the projection-plane-side shield plate 800 shown in any of FIGS. 13 to 15 is provided.

As FIG. 16 shows, in the case where the projection-plane-side shield plate 800 shown in any of FIGS. 13 to 15 is provided, the unwanted light 710 existing along the lower edge of the image light 700 is shielded. Since the projection-plane-side shield plate 800 shown in any of FIGS. 13 to 15 has an area having a predetermined transmittance on both end portions thereof in the horizontal direction parallel to the projection plane 300 (in the width direction of the housing case 200), portions of the unwanted light 710 are left at lower parts of the unwanted light 720 and the unwanted light 730, respectively (a boundary portion 710A and a boundary portion 710B). Accordingly, light-dark boundaries are not noticeable at the lower ends of the unwanted light 720 and the unwanted light 730, respectively.

### (Advantageous Effects)

In modification 1, the projection-plane-side shield plate 800 has an area having a predetermined transmittance at each of its end portions in the horizontal direction parallel to the projection plane 300 (in the width direction of the housing case 200). Accordingly, it is possible to make unnoticeable the light-dark boundaries at the lower ends of the unwanted light 720 and the unwanted light 730, respectively.

### [Modification 2]

Modification 2 of the first embodiment will be described below with reference to the drawings. Differences from the first embodiment are mainly described below.

Specifically, in modification 2, the ceiling plate 240 is provided with an enlarged recessed portion having a substantially horizontal bottom face. The ceiling-plate recessed portion 180 is provided in the bottom face of the enlarged recessed portion.

### (Configuration of the Ceiling Plate)

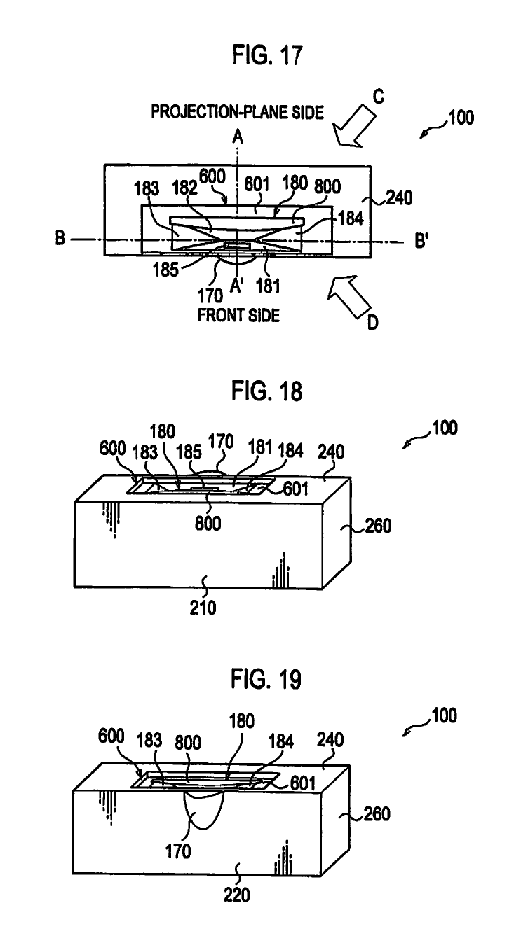

Hereinafter, a configuration of the ceiling plate according to Modification 2 will be described with reference to the drawings. FIGS. 17 to 19 are views showing a ceiling plate 240 according to modification 2.

Specifically, FIG. 17 is a view of the projection display apparatus 100 seen from the ceiling plate 240 side. FIG. 18 is a view of the projection display apparatus 100 seen in a direction C in FIG. 17. FIG. 19 is a view of the projection display apparatus 100 seen in a direction D in FIG. 17.

As FIGS. 17 to 19 show, the ceiling plate 240 is provided with an enlarged recessed portion 600 having a substantially horizontal bottom face 601. The ceiling-plate recessed portion 180 described above is provided in the bottom face 601 of the enlarged recessed portion 600. Side faces forming walls around the enlarged recessed portion 600 preferably incline at a substantially right angle to the bottom face 601.

The configuration of the ceiling-plate recessed portion 180 is the same as that in the first embodiment, and therefore the description therefore is omitted here.

The projection-plane-side shield plate 800 is provided on the bottom face 601 of the enlarged recessed portion 600. Further, as in the first embodiment, the projection-plane-side shield plate 800 has a curved shape bulging over the inclined surface 182.

### [Modification 3]

Modification 3 of the first embodiment will be described below with reference to the drawing. Differences from the first embodiment are mainly described below.

Specifically, in modification 3, the ceiling plate 240 is provided with not only the projection-plane-side shield plate 800, but also side shield plates that are placed adjacently to the transmission area 185 in the horizontal direction parallel to the projection plane 300.

### (Configuration of the Projection Display Apparatus)

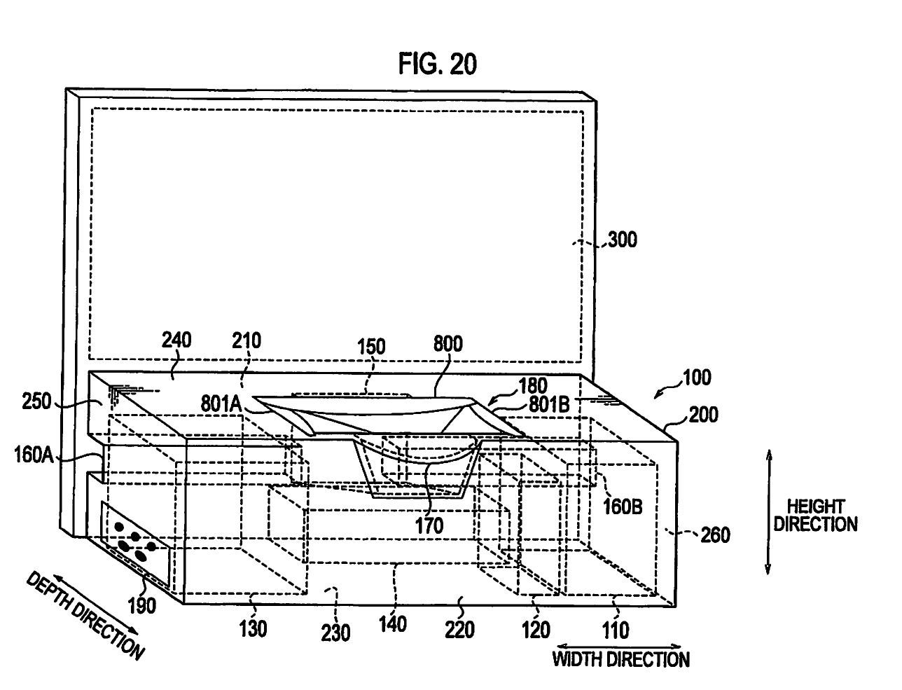

Hereinafter, a configuration of the projection display apparatus according to modification 3 will be described with reference to the drawings. FIG. 20 is a perspective view showing a projection display apparatus 100 according to modification 3.

As FIG. 20 shows, in addition to the projection-plane-side shield plate 800, the ceiling plate 240 includes a side shield plate 801A and a side shield plate 801B.

The side shield plate 801A and the side shield plate 801B are placed adjacently to the transmission area 185 (not shown in FIG. 20) in the horizontal direction parallel to the projection plane 300 (in the width direction of the housing case 200). The side shield plate 801A and the side shield plate 801B each have a shape extending in the orthogonal direction to the projection plane 300 (the depth direction of the housing case 200).

The side shield plate 801A and the side shield plate 801B are each formed of a shielding member (e.g., a black sheet metal or a black acrylic sheet), and configured to shield light other than that forming an image, namely unwanted light (the unwanted light 720 and the unwanted light 730 described above), among light that has passed through the transmission area 185.

In addition, the side shield plate 801A and the side shield plate 801B each have a curved shape bulging toward the inside of the ceiling-plate recessed portion 180 so as to shield the unwanted light 720 and the unwanted light 730.

### (Advantageous Effects)

In modification 3, the ceiling plate 240 is provided with the side shield plate 801A and the side shield plate 801B placed adjacently to the transmission area 185 in the horizontal direction parallel to the projection plane 300 (in the width direction of the housing case 200). The side shield plate 801A and the side shield plate 801B are configured to shield light other than that forming an image, namely unwanted light (the unwanted light 720 and the unwanted light 730), among light that has passed through the transmission area 185. Accordingly, near the projection plane 300 where an image plane is formed, the side shield plate 801A and the side shield plate 801B shield unwanted light. Thus, compared to a case where an aperture, provided near a reflective light valve in which an object plane is formed, is used to shield unwanted light, the projection-plane-side shield plate 800 and the side shield plates 801A and 801B can sufficiently remove unwanted light reflected by the reflective light valve.

### [Modification 4]

Modification 4 of the first embodiment will be described below with reference to the drawing. Differences from the first embodiment and modification 3 are mainly described below.

Specifically, in the first embodiment and modification 3, the projection-plane-side shield plate 800, the side shield plate 801A, and the side shield plate 801B are placed bulging toward the inside of the ceiling-plate recessed portion 180. In contrast, in modification 4, the projection-plane-side shield plate 800, the side shield plate 801A, and the side shield plate 801B are placed protruding upward of the ceiling plate 240.

### (Configuration of the Projection Display Apparatus)

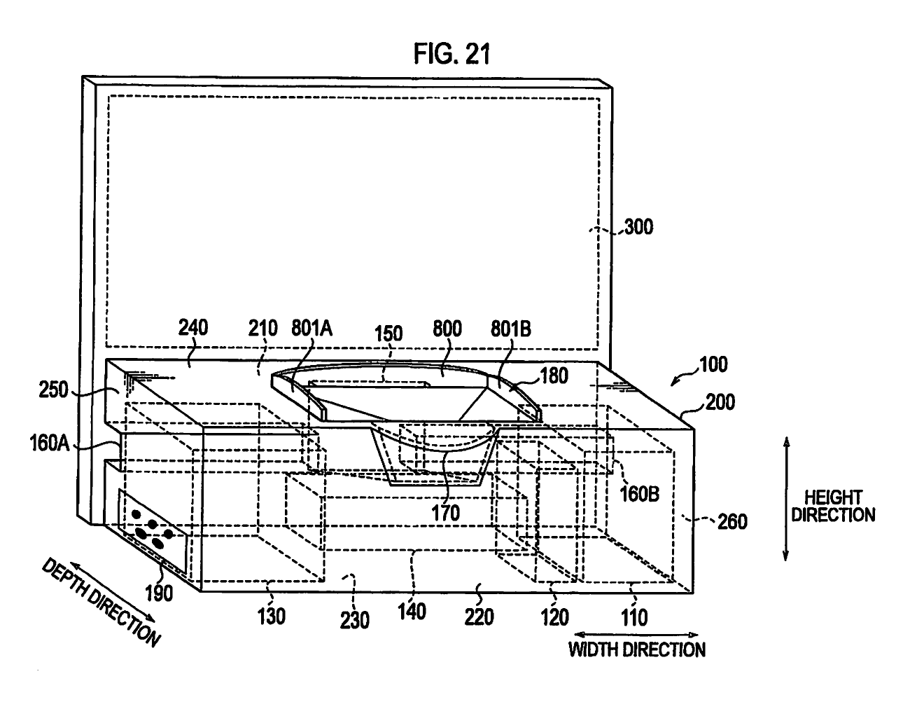

Hereinafter, a configuration of the projection display apparatus according to modification 4 will be described with reference to the drawings. FIG. 21 is a perspective view showing a projection display apparatus 100 according to modification 4.

As FIG. 21 shows, like modification 3, the ceiling plate 240 includes the projection-plane-side shield plate 800 as well as the side shield plate 801A and the side shield plate 801B.

The side shield plate 801A and the side shield plate 801B are placed adjacently to the transmission area 185 (not shown in FIG. 21) in the horizontal direction parallel to the projection plane 300 (in the width direction of the housing case 200). The side shield plate 801A and the side shield plate 801B each have a shape extending in the orthogonal direction to the projection plane 300 (the depth direction of the housing case 200).

The side shield plate 801A and the side shield plate 801B are each formed of a shielding member (e.g., a black sheet metal or a black acrylic sheet), and configured to shield light other than that forming an image, namely unwanted light (the unwanted light 720 and the unwanted light 730 described above), among light that has passed through the transmission area 185.

In modification 4, the side shield plate 801A and the side shield plate 801B are placed protruding upward of the ceiling plate 240. Further, the side shield plate 801A and the side shield plate 801B each have a curved shape bulging upward of the ceiling-plate recessed portion 180 so as to shield the unwanted light 720 and the unwanted light 730.

### Second Embodiment

Hereinafter, a second embodiment will be described with reference to the drawings. Differences from the first embodiment will be mainly described below.

Specifically, the first embodiment has been illustrated for the case where the projection display apparatus 100 projects image light onto the projection plane 300 provided to the wall surface. In contrast, the second embodiment will be illustrated for a case where a projection display apparatus 100 projects image light onto a projection plane 300 provided on a floor surface (floor surface projection). An arrangement of a housing case 200 in this case is referred to as a floor surface projection arrangement.

### (Configuration of Projection Display Apparatus)

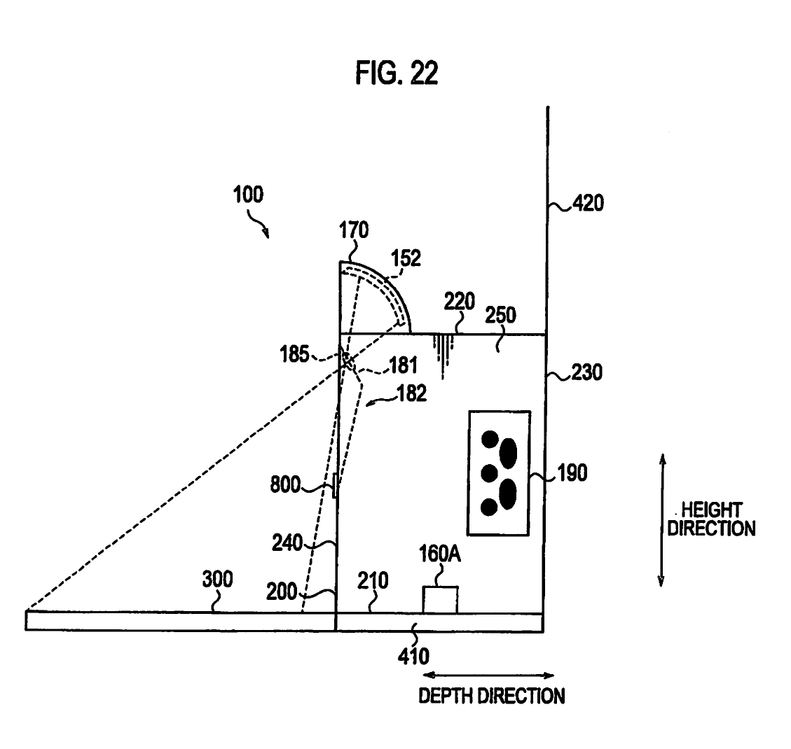

Hereinafter, description will be provided for a configuration of a projection display apparatus according to the second embodiment with reference to FIG. 22. FIG. 22 is a view of a projection display apparatus 100 according to the second embodiment when viewed from side.

As shown in FIG. 22, the projection display apparatus 100 projects image light onto the projection plane 300 provided on the floor surface (floor surface projection). In the second embodiment, a floor surface 410 is a first placement surface substantially parallel to the projection plane 300, and a wall surface 420 is a second placement surface substantially orthogonal to the first placement surface.

In the second embodiment, a horizontal direction parallel to the projection plane 300 is referred to as “a width direction”, an orthogonal direction to the projection plane 300 is referred to as “a height direction”, and an orthogonal direction crossing both the width direction and the height direction is referred to as “a depth direction”.

In the second embodiment, the housing case 200 has a substantially rectangular parallelepiped shape as similar to the first embodiment. The size of the housing case 200 in the depth direction and the size of the housing case 200 in the height direction are smaller than the size of the housing case 200 in the width direction. The size of the housing case 200 in the height direction is almost equal to a projection distance from a reflection mirror (the concave mirror 152 shown in FIG. 2) to the projection plane 300. In the width direction, the size of the housing case 200 is almost equal to the size of the projection plane 300. In the depth direction, the size of the housing case 200 is determined depending on a distance from the wall surface 420 to the projection plane 300.

A projection-plane-side sidewall 210 is a plate-shaped member facing the first placement surface (the floor surface 410 in the second embodiment) substantially parallel to the projection plane 300. A front-side sidewall 220 is a plate-shaped member provided on the side opposite from the projection-plane-side sidewall 210. A ceiling plate 240 is a plate-shaped member provided on the side opposite from a base plate 230. The base plate 230 is a plate-shaped member facing the second placement surface (the wall surface 420 in the second embodiment) different from the first placement surface substantially parallel to the projection plane 300. A first-lateral-surface-side sidewall 250 and a second-lateral-surface-side sidewall 260 are plate-shaped members forming both ends of the housing case 200 in the width direction.

### Third Embodiment

A third embodiment will be described below with reference to the drawings. Differences from the first embodiment are mainly described below. Specifically, in the third embodiment, the position and the angle of the projection-plane-side shield plate 800 are adjustable.

For example, the position and the angle of the projection-plane-side shield plate 800 are adjustable as follows. (1) The position of the projection-plane-side shield plate 800 is adjustable in the orthogonal direction to the projection plane 300 (in the depth direction). (2) The angle of the projection-plane-side shield plate 800 is adjustable around an axis extending in the horizontal direction parallel to the projection plane 300 (in the width direction). (3) The position of the projection-plane-side shield plate 800 is adjustable in the direction (the height direction) orthogonal to both of the horizontal direction parallel to the projection plane 300 (the width direction) and the orthogonal direction to the projection plane 300 (the depth direction).

Note that any one of, or more than one of, the positions and the angle in (1) to (3) may be adjusted.

### FIRST CONFIGURATION EXAMPLE

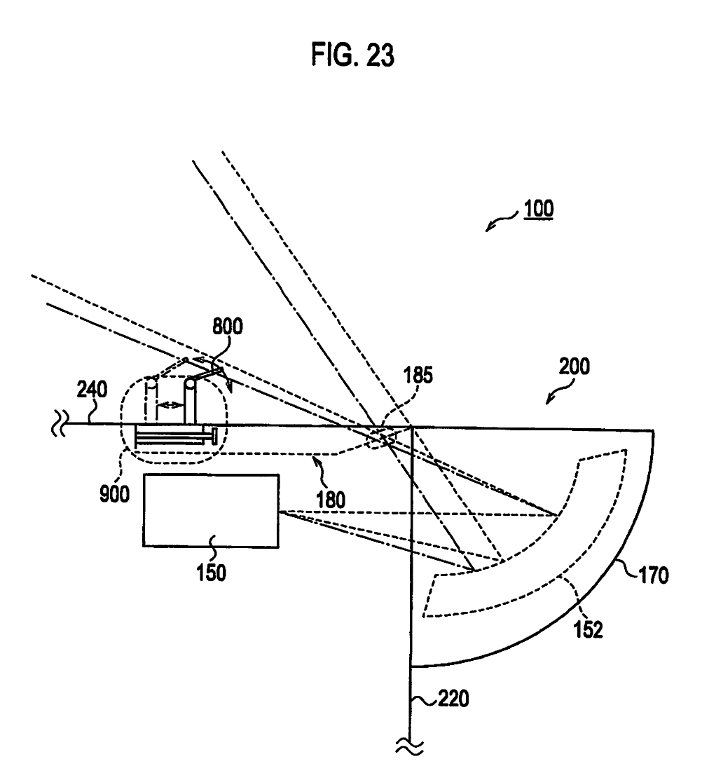

Hereinafter, a first configuration example for adjusting the position and the angle of the projection-plane-side shield plate 800 with reference to the drawings. FIG. 23 is a view showing the first configuration example for adjusting the position and the angle of the projection-plane-side shield plate 800. Specifically, FIG. 23 is an enlarged view of an area around the projection-plane-side shield plate 800.

As FIG. 23 shows, the projection display apparatus 100 includes a support mechanism 900 configured to support the projection-plane-side shield plate 800.

The support mechanism 900 is configured to support the projection-plane-side shield plate 800 movable in the orthogonal direction to the projection plane 300 (in the depth direction). Moreover, the support mechanism 900 is configured to support the projection-plane-side shield plate 800 rotatable around the axis extending in the horizontal direction parallel to the projection plane 300 (in the width direction).

The support mechanism 900 is provided to the ceiling plate 240 of the housing case 200. For example, the support mechanism 900 is placed inside the ceiling-plate recessed portion 180 of the ceiling plate 240.

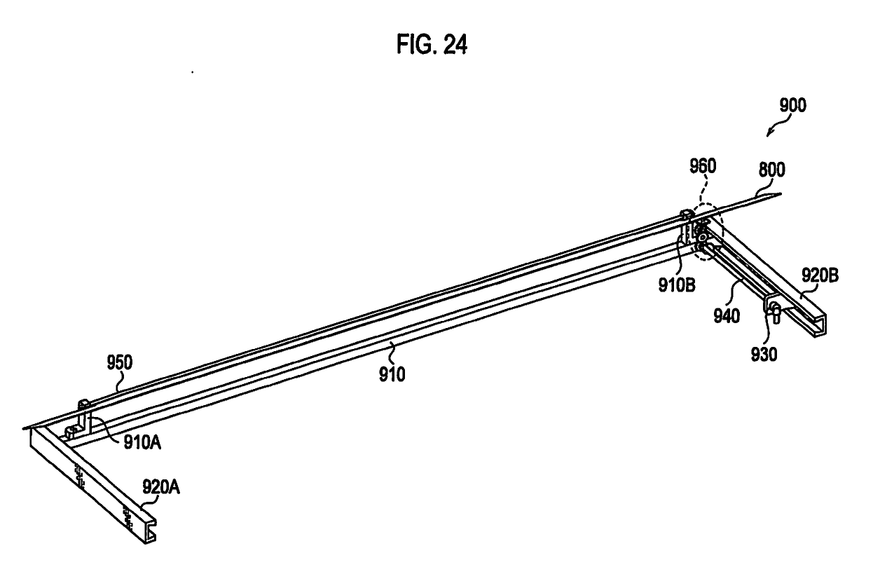

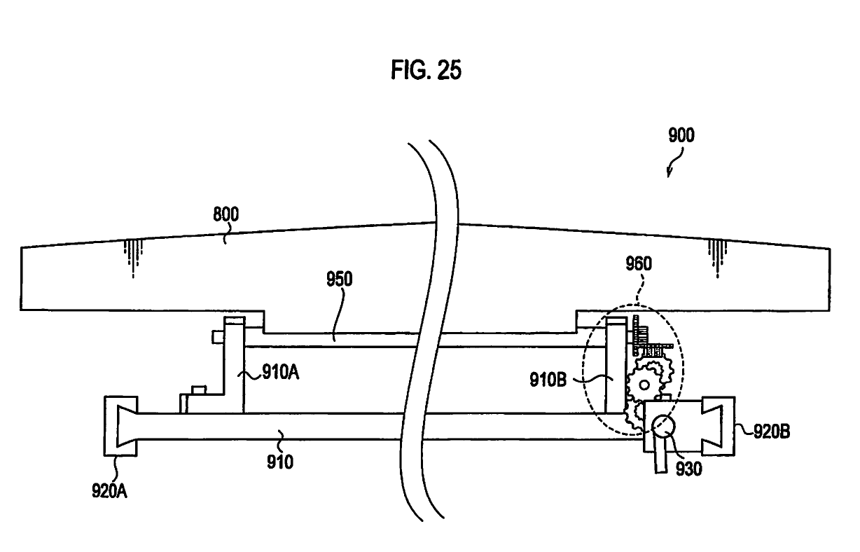

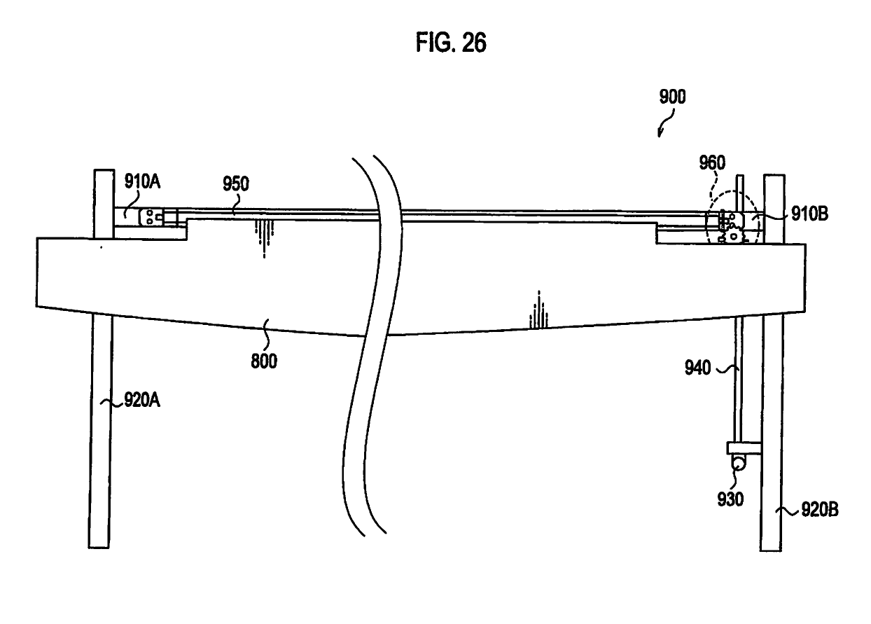

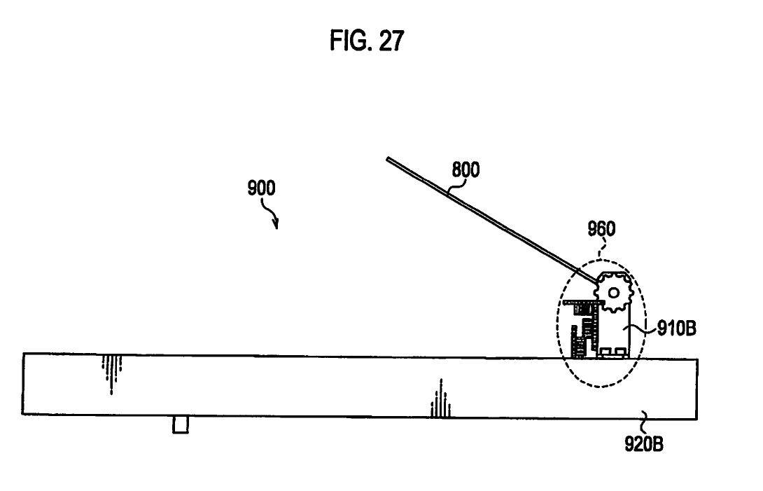

Here, details of the first configuration example of the support mechanism 900 are described with reference to FIGS. 24 to 27. FIG. 24 is a perspective view of the support mechanism 900. FIG. 25 is a view of the support mechanism 900 seen from the front side thereof. FIG. 26 is a view of the support mechanism 900 seen from the upper side thereof. FIG. 27 is a view of the support mechanism 900 seen from a lateral side thereof.

As FIGS. 24 to 27 show, the support mechanism 900 includes a base 910, rails 920, a first cam mechanism 930, a feed screw 940, a rotary shaft 950, and a second cam mechanism 960.

The base 910 has a shape extending in the horizontal direction parallel to the projection plane 300 (in the width direction). Widthwise end portions of the base 910 are fitted into the respective rails 920.

A base 910A and a base 910B are provided on the respective widthwise end portions of the base 910. The base 910A and the base 910B are configured to rotatably support the rotary shaft 950 extending in the horizontal direction parallel to the projection plane 300 (in the width direction). As will be described later, the projection-plane-side shield plate 800 is fixed to the rotary shaft 950. Accordingly, the base 910A and the base 910B support the projection-plane-side shield plate 800 around the rotary shaft 950.

One of the widthwise end portions of the base 910 (the end portion where the base 910B is provided) has a screw hole which receives the feed screw 940. The screw hole has a spiral concave portion that engages with a spiral convex portion provided to the feed screw 940.

Each of the rails 920 has a groove that slidably supports the corresponding end portion of the base 910. The groove provided in the rail 920 extends in the orthogonal direction to the projection plane 300 (in the depth direction).

The first cam mechanism 930 is fixed to one of the rails 920. The first cam mechanism 930 is connected to the feed screw 940. Note that the first cam mechanism 930 is connected to a focus adjustment mechanism and a zoom adjustment mechanism of the projection unit 150 (both not shown), and is configured to rotate the feed screw 940 in conjunction with focus adjustment and zoom adjustment by the projection unit 150.

The feed screw 940 has the spiral convex portion. The feed screw 940 is screwed into the screw hole provided in the one end portion of the base 910. Meanwhile, the feed screw 940 is connected to the first cam mechanism 930.

According to the rotation amount of the feed screw 940, the base 910 described above moves along the rails 920, namely, in the orthogonal direction to the projection plane 300 (in the depth direction). In other words, according to the rotation amount of the feed screw 940, the projection-plane-side shield plate 800 supported by the base 910 moves in the orthogonal direction to the projection plane 300 (in the depth direction).

The rotary shaft 950 has a shape extending in the horizontal direction parallel to the projection plane 300 (in the width direction). The rotary shaft 950 is fixed to the projection-plane-side shield plate 800, and is rotatably supported by the base 910A and the base 910B.

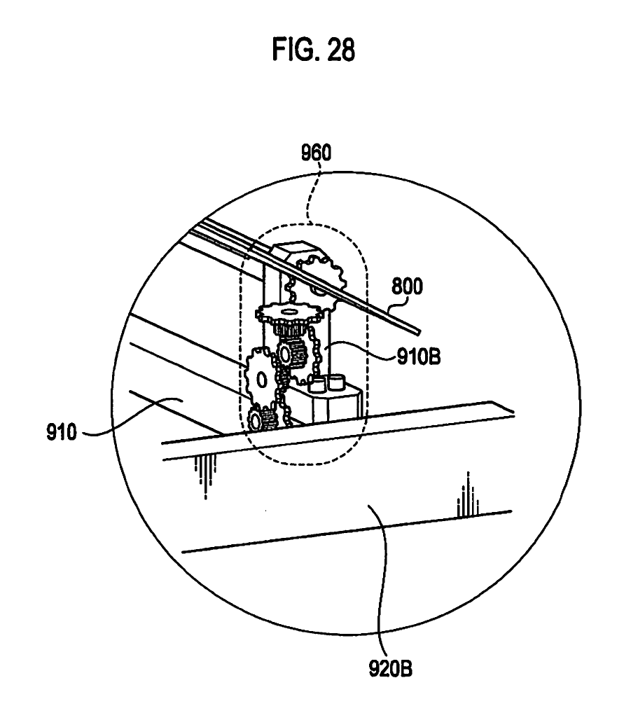

The second cam mechanism 960 is provided on one of the end portions of the base 910 (the end portion where the base 910B is provided). More specifically, as FIG. 28 shows, the second cam mechanism 960 is formed of multiple cams. The multiple cams include a cam configured to engage with the spiral convex portion provided to the feed screw 940. Further, the multiple cams include a cam configured to rotate around the rotary shaft 950. Accordingly, the projection-plane-side shield plate 800 fixed to the rotary shaft 950 rotates around the rotary shaft 950 in conjunction with the rotation of the feed screw 940.

As described, in conjunction with the projection-plane-side shield plate 800 moving in the orthogonal direction to the projection plane 300 (in the depth direction), the projection-plane-side shield plate 800 rotates around the rotary shaft 950.

The second cam mechanism 960 is configured to adjust the move amount and the rotation amount of the projection-plane-side shield plate 800 so as to shield unwanted light (unwanted light 710) which is other than light constructing an image.

Specifically, in conjunction with focus adjustment and zoom adjustment by the projection unit 150, the first cam mechanism 930 rotates the feed screw 940. Thereby, adjustments are made on the position of the projection-plane-side shield plate 800 in the depth direction and the rotation angle of the projection-plane-side shield plate 800 rotating around the rotary shaft 950.

### SECOND CONFIGURATION EXAMPLE

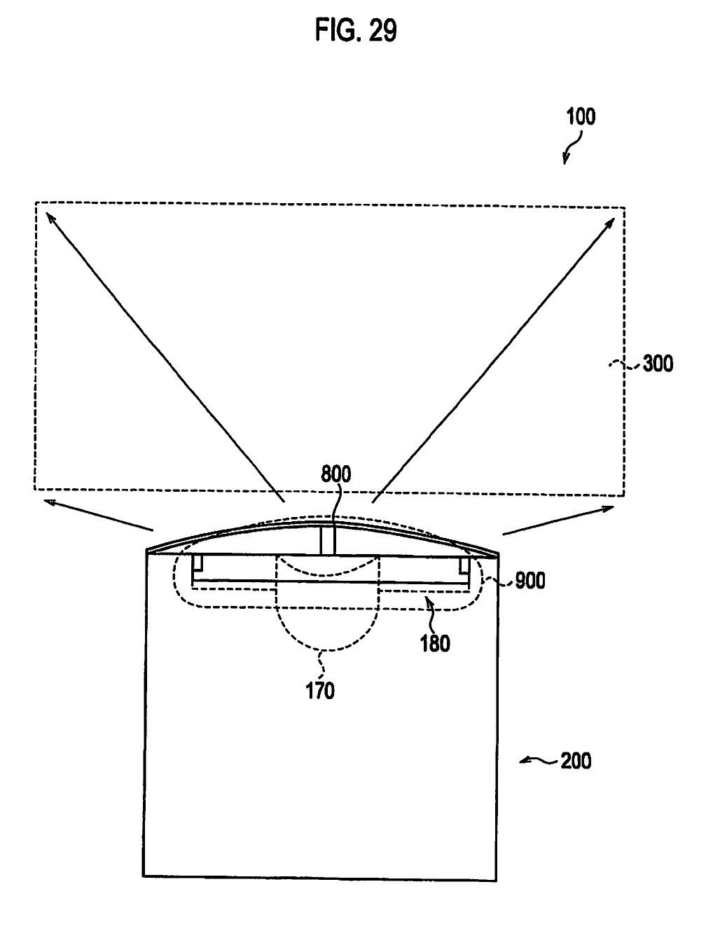

Hereinafter, a second configuration example for adjusting the position and the angle of the projection-plane-side shield plate 800 with reference to the drawings. FIG. 29 is a view showing the second configuration example for adjusting the position of the projection-plane-side shield plate 800. Specifically, FIG. 29 is an enlarged view of an area around the projection-plane-side shield plate 800.

As FIG. 29 shows, the projection display apparatus 100 includes a support mechanism 900 configured to support the projection-plane-side shield plate 800.

The support mechanism 900 is configured to support the projection-plane-side shield plate 800 movable in the orthogonal direction to the projection plane 300 (in the depth direction). Moreover, the support mechanism 900 is configured to support the projection-plane-side shield plate 800 movable in the direction (the height direction) orthogonal to both of the horizontal direction parallel to the projection plane 300 (the width direction) and the orthogonal direction to the projection plane 300 (the depth direction).

As in the first configuration example, the support mechanism 900 is provided to the ceiling plate 240 of the housing case 200. For example, the support mechanism 900 is placed inside the ceiling-plate recessed portion 180 of the ceiling plate 240.

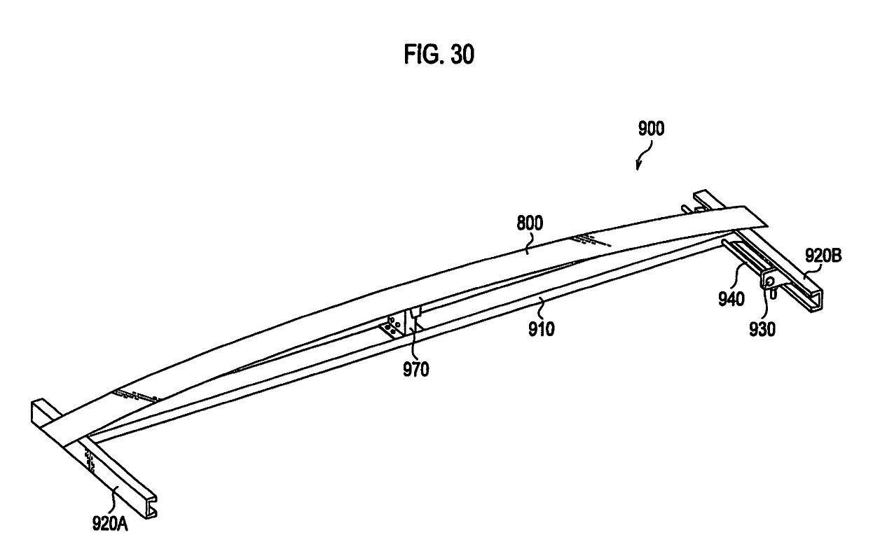

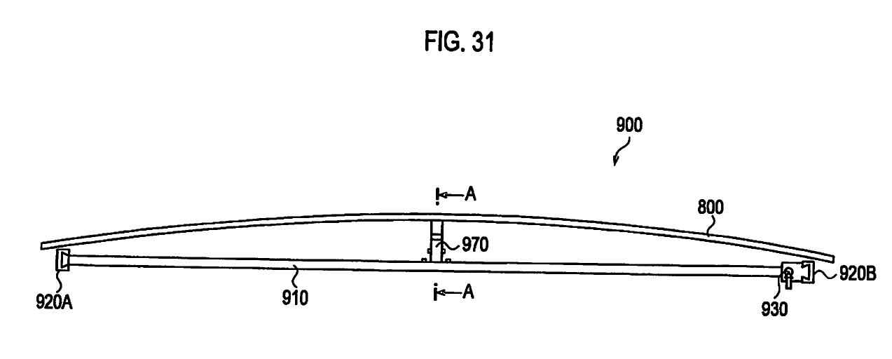

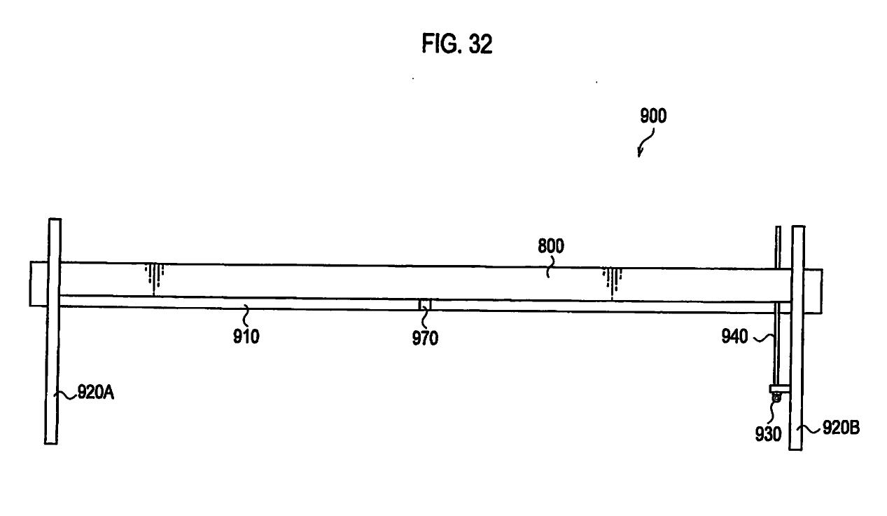

Here, details of the second configuration example of the support mechanism 900 are described with reference to FIGS. 30 to 32. FIG. 30 is a perspective view of the support mechanism 900. FIG. 31 is a view of the support mechanism 900 seen from the front side thereof. FIG. 32 is a view of the support mechanism 900 seen from the upper side thereof.

As FIGS. 30 to 32 show, the support mechanism 900 includes the base 910, the rails 920, the first cam mechanism 930, the feed screw 940, and a stage 970. Since the configurations of the base 910, the rails 920, the first cam mechanism 930, and the feed screw 940 are the same as those in the first configuration example, the descriptions therefore are omitted here.

The stage 970 is placed at a substantially center portion of the base 910 in the horizontal direction parallel to the projection plane 300 (in the width direction). Further, the stage 970 is configured to move the projection-plane-side shield plate 800 in the direction (the height direction) orthogonal to both of the horizontal direction parallel to the projection plane 300 (the width direction) and the orthogonal direction to the projection plane 300 (the depth direction).

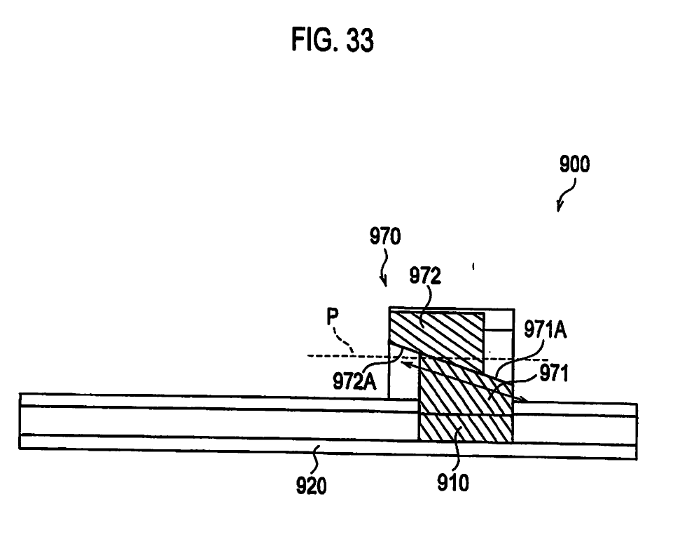

Here, details of the stage 970 are described with reference to FIG. 33. FIG. 33 is a cross-sectional view taken along an A-A line shown in FIG. 31.

As FIG. 33 shows, the stage 970 includes a first stage 971 and a second stage 972. The first stage 971 has an inclined surface 971A that inclines with respect to a plane P orthogonal to the projection plane 300. Similarly, the second stage 972 has an inclined surface 972A that inclines with respect to the plane P orthogonal to the projection plane 300. The inclined surface 971A and the inclined surface 972A face each other. The first stage 971 is configured to be slidable along the interface between the inclined surface 971A and the inclined surface 972A.

The first stage 971 is fixed to the base 910, and moves along with the base 910 in the orthogonal direction to the projection plane 300 (in the depth direction). Meanwhile, the second stage 972 is fixed to the housing case 200 and the like, and does not move in the orthogonal direction to the projection plane 300 (in the depth direction). Further, the second stage 972 supports the projection-plane-side shield plate 800.

As described, as the first stage 971 moves in the orthogonal direction to the projection plane 300 (in the depth direction), the first stage 971 slides along the interface between the inclined surface 971A and the inclined surface 972A. This moves the second stage 972 in the direction (the height direction) orthogonal to both of the horizontal direction parallel to the projection plane 300 (the width direction) and the orthogonal direction to the projection plane 300 (the depth direction), and thereby also moves the projection-plane-side shield plate 800 supported by the second stage 972.

In the second configuration example, the projection-plane-side shield plate 800 has a rectangular plate shape. Further, the projection-plane-side shield plate 800 has a shape whose center portion in the horizontal direction parallel to the projection plane 300 (in the width direction) curves upward. As in the first embodiment, the projection-plane-side shield plate 800 having such shape can shield the unwanted light 710 existing along the lower edge of the image light 700 even if the projection-plane-side shield plate 800 does not have the curved shape bulging over the inclined surface 182.

### (Advantageous Effects)

In the first configuration example of the third embodiment, the support mechanism 900 supports the projection-plane-side shield plate 800 movable in the orthogonal direction to the projection plane 300 (in the depth direction), and to rotate around the rotary shaft 950 extending in the horizontal direction parallel to the projection plane 300 (the width direction).

In the second configuration example of the third embodiment, the support mechanism 900 supports the projection-plane-side shield plate 800 movable in the orthogonal direction to the projection plane 300 (in the depth direction), and to move in the direction (the height direction) orthogonal to both of the horizontal direction parallel to the projection plane 300 (the width direction) and the orthogonal direction to the projection plane 300 (the depth direction).

Accordingly, the unwanted light 710 existing along the lower edge of the image light 700 can be appropriately shielded, even when the light path of the unwanted light 710 to be shielded by the projection-plane-side shield plate 800 changes as a result of, for example, focus adjustment or zoom adjustment by the projection unit 150.

### Other Embodiments

As described above, the details of the present invention have been described by using the embodiments of the present invention. However, it should not be understood that the description and drawings which constitute part of this disclosure limit the present invention. From this disclosure, various alternative embodiments, examples, and operation techniques will be easily found by those skilled in the art.

In the first embodiment, the projection plane 300 is provided on the wall surface 420 on which the housing case 200 is arranged. However, an embodiment is not limited to this case. The projection plane 300 may be provided in a position behind the wall surface 420 in a direction away from the housing case 200.

In the second embodiment, the projection plane 300 is provided on the floor surface 410 on which the housing case 200 is arranged. However, an embodiment is not limited to this case. The projection plane 300 may be provided in a position lower than the floor surface 410.

In the embodiments, a DMD (a digital micromirror device) has been used merely as an example of the light valve. The light valve may be a reflective liquid crystal panel.

In the embodiments, as an example, a laser diode (LD) is used as the light source. However, the light source is not limited to an LD, and may be, for example, a light emitting diode (LED), a UHP lamp, a xenon lamp, or the like.

In the embodiments, as an example of a method of cooling the light source, liquid cooling is used. However, the method of cooling the light source is not limited to the liquid cooling method, and may be, for example, air cooling method.

In the embodiments, light beams having been emitted from the LDs and passed through the optical fibers are collected at the bundle unit, and the rod integrator is used as means to equalize the light beams. However, the embodiments are not limited to this case. For example, when fly-eye lenses are used as the means for equalizing the light beams, the optical fibers and the bundle unit may be omitted.

Although not particularly mentioned in the embodiments, the projection-plane-side shield plate 800, the side shield plate 801A, and the side shield plate 801B may be configured so that the arrangement of the projection-plane-side shield plate 800, the side shield plate 801A, and the side shield plate 801B can be adjusted. Specifically, the projection-plane-side shield plate 800 may be configured to be movable in the orthogonal direction to the projection plane 300 (e.g., in the depth direction). Further, the side shield plate 801A and the side shield plate 801B each may be configured to be movable in the horizontal direction substantially parallel to the projection plane 300 (in the width direction of the housing case 200).

In the third embodiment, the position or the angle of the projection-plane-side shield plate 800 is controlled in conjunction with focus adjustment or zoom adjustment by the projection unit 150. However, the embodiments are not limited to such case. The position or the angle of the projection-plane-side shield plate 800 may be adjusted manually.

In the first configuration example of the third embodiment, the position and the angle of the projection-plane-side shield plate 800 are adjusted in conjunction with each other. However, the embodiments are not limited to such case. The position and the angle of the projection-plane-side shield plate 800 may be adjusted independent from each other.

In the second configuration example of the third embodiment, the position of the projection-plane-side shield plate 800 in the depth direction and that in the height direction are adjusted in conjunction with each other. However, the embodiments are not limited to such case. The position of the projection-plane-side shield plate 800 in the depth direction and that in the height direction may be adjusted independent from each other.

The term “substantially” allows a margin of ±10%, when the term “substantially” is used for structural meaning. On the other hand, The term “substantially” allows a margin of ±5%, when the term “substantially” is used for optical meaning.

What is claimed is:

1. A projection display apparatus comprising a housing case configured to house: a light source; a reflective light valve configured to modulate light emitted from the light source; and a projection unit configured to project light emitted from the reflective light valve on a projection plane, the projection display apparatus being placed along a first placement face substantially parallel to the projection plane and along a second placement face substantially orthogonal to the first placement face, wherein
the housing case has a base plate and a ceiling plate, the base plate facing the second placement face, the ceiling plate being provided on an opposite side to the base plate,
the ceiling plate is provided with a transmission area and a projection-plane-side shield plate, the transmission area being an area through which light emitted from the projection unit passes, the projection-plane-side shield plate being placed closer to the projection plane than the transmission area, and
the projection-plane-side shield plate is configured to shield unwanted light being other than light forming an image among light passed through the transmission area.

2. The projection display apparatus according to claim 1, wherein
the ceiling plate has a side shield plate provided adjacently to the transmission area in a horizontal direction parallel to the projection plane, and
the side shield plate is configured to shield unwanted light being other than light forming an image among light passed through the transmission area.

3. The projection display apparatus according to claim 1, wherein
the projection-plane-side shield plate has a shape extending in a horizontal direction parallel to the projection plane, and
an area having a predetermined transmittance is provided to each of end portions of the projection-plane-side shield plate in the horizontal direction parallel to the projection plane.

4. The projection display apparatus according to claim 1, further comprising a support mechanism configured to support the projection-plane-side shield plate movable in an orthogonal direction to the projection plane.

5. The projection display apparatus according to claim 1, further comprising a support mechanism configured to support the projection-plane-side shield plate movable in a direction orthogonal to both of a horizontal direction parallel to the projection plane and a direction normal to the projection plane.
